(19) United States
(12) Patent Application Publication
(10) Pub. No.: US 2016/0135107 A1
(43) Pub. Date: May 12, 2016

(54) MIGRATION OF LOCAL ANCHORS IN A WIRELESS MESH NETWORK

(71) Applicant: QUALCOMM Incorporated, San Diego, CA (US)

(72) Inventors: Karl Georg Hampel, New York, NY (US); Vincent Park, Budd Lake, NJ (US)

(21) Appl. No.: 14/866,674

(22) Filed: Sep. 25, 2015

Related U.S. Application Data
(60) Provisional application No. 62/076,408, filed on Nov. 6, 2014.

(51) Int. Cl. H04W 40/02; H04L 12/46; H04W 76/02; H04W 28/02

(52) U.S. Cl. CPC H04W 40/02; H04W 28/0252; H04L 12/4633; H04W 76/02; H04W 84/18

(57) ABSTRACT

Methods, apparatus, and systems for wireless communication are provided. A method for wireless communication at a user equipment (UE) includes establishing a connection between the UE and an attachment node of a wireless mesh network. The wireless mesh network can include a plurality of interconnected mesh nodes and a first local anchor of a radio access network. The method can also include establishing a bearer between the UE and a global anchor of the radio access network, and communicating with a core network using the bearer. Bearer traffic may be carried through the wireless mesh network and relayed through the first local anchor. The bearer traffic may be carried through the wireless mesh network on a path determined by a routing plane of the wireless mesh network. The routing plane may be maintained using a distributed routing protocol. Other aspects, embodiments, and features are also claimed and described.

### CROSS-REFERENCE TO RELATED APPLICATIONS

This application claims priority to and the benefit of U.S. provisional patent application No. 62/076,408 filed Nov. 6, 2014, the entire content of which being incorporated herein by reference and for all applicable purposes.

### TECHNICAL FIELD

The present disclosure relates generally to communication systems, and more particularly, to providing connections between wide area networks and wireless devices leveraging mesh networks. Certain aspects enable and provide relay solutions for cellular networks supporting multi-hop relaying mesh topologies and relay-node mobility.

### INTRODUCTION

Multiple access technologies have been adopted in various telecommunication standards to provide a common protocol that enables different wireless devices to communicate on a municipal, national, regional, and even global level. Emerging telecommunication standards include fourth generation (4G) technologies such as Long Term Evolution (LTE), and fifth generation (5G) technologies. LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using orthogonal frequency-division multiple access (OFDMA) on the downlink (DL), SC-FDMA on the uplink (UL), and multiple-input multiple-output (MIMO) antenna technology.

As the demand for mobile broadband access continues to increase, there exists a need for further improvements in wireless communications technologies. Preferably, improvements should be applicable to other multi-access technologies and the telecommunication standards that employ these technologies.

### BRIEF SUMMARY OF SOME EXAMPLES

The following summarizes some aspects of the present disclosure in order to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts related to one or more aspects of the disclosure in summary form as a prelude to the more detailed description that is presented later.

In an aspect of the disclosure, methods, systems and apparatus are described that enable traffic between a subscriber station, or user equipment (UE), associated with a wide area radio access network and a corresponding entity of the radio access network, such as a scheduling entity, to be relayed through a wireless mesh network that employs short range communications methods to connect a plurality of low-power mobile devices.

According to certain aspects, a method for wireless communication performed at the UE may include establishing, via the UE a connection with a first node of a wireless mesh network, communicating from the UE through the first node of the wireless network to a first local anchor of a radio access network using a routing plane of the wireless mesh network, and transmitting one or more packets to a corresponding entity external to the wireless mesh network. The one or more packets may be transmitted through the first local anchor using a first path determined by the routing plane of the wireless mesh network.

According to certain aspects, an apparatus for wireless communication performed at the UE may include means for establishing, via the UE a connection with a first node of a wireless mesh network, means for communicating from the UE through the first node of the wireless network to a first local anchor of a radio access network using a routing plane of the wireless mesh network, and means for transmitting one or more packets to a corresponding entity external to the wireless mesh network. The one or more packets may be transmitted through the first local anchor using a first path determined by the routing plane of the wireless mesh network.

According to certain aspects, a computer-readable storage medium may store code executable by one or more processors of a processing circuit. The code may cause the processing circuit to establish, via a UE, a connection with a first node of a wireless mesh network, communicate from the UE through the first node of the wireless network to a first local anchor of a radio access network using a routing plane of the wireless mesh network, and transmit one or more packets to a corresponding entity external to the wireless mesh network. The one or more packets may be transmitted through the first local anchor using a first path determined by the routing plane of the wireless mesh network.

According to certain aspects, a method for wireless communication performed at a local anchor of a wide area radio access network may include establishing a connection through a wireless mesh network with a subscriber station of the wide area radio access network, where the connection through the wireless mesh network is managed by a routing plane of the wireless mesh network, establishing a connection with a management entity of the radio access network external to the wireless mesh network, and relaying packets between the subscriber station and the management entity using the wireless mesh network to relay the packets to the subscriber station over a first path determined by the routing plane of the wireless mesh network.

According to certain aspects, an apparatus includes means for establishing a connection through a wireless mesh network with a subscriber station of the wide area radio access network, where the connection through the wireless mesh network is managed by a routing plane of the wireless mesh network, means for establishing a connection with a management entity of the radio access network external to the wireless mesh network, and means for relaying packets between the subscriber station and the management entity using the wireless mesh network to relay the packets to the subscriber station over a first path determined by the routing plane of the wireless mesh network.

According to certain aspects, a computer-readable storage medium may store code executable by one or more processors of a processing circuit. The code may cause the processing circuit to establish a connection through a wireless mesh network with a subscriber station of the wide area radio access network, where the connection through the wireless mesh network is managed by a routing plane of the wireless mesh network, establish a connection with a management entity of the radio access network external to the wireless mesh network, and relay packets between the subscriber station and the management entity using the wireless mesh network to relay the packets to the subscriber station over a first path determined by the routing plane of the wireless mesh network.

According to certain aspects, a local anchor coupled to a wide area radio access network, may include a wireless transceiver configured to couple the apparatus to a wireless mesh network, and at least one processing circuit. The at least one processing circuit may be configured to establish a connection through the wireless mesh network with a subscriber station of the wide area radio access network, where the connection through the wireless mesh network is managed by a routing plane of the wireless mesh network, establish a connection with a management entity of the radio access network external to the wireless mesh network, and relay packets between the subscriber station and the management entity using the wireless mesh network to relay the packets to the subscriber station over a first path determined by the routing plane of the wireless mesh network.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a network architecture according to certain aspects.

FIG. 2 is a diagram illustrating an example of a RAN according to certain aspects.

FIG. 3 is a diagram illustrating an example of a radio protocol architecture according to certain aspects.

FIG. 4 illustrates an example of a protocol stack that may be implemented in a communication device operating in the example of LTE packet-switched networks according to certain aspects.

FIG. 5 is a diagram illustrating an example of an access point and subscriber station deployed in a RAN according to certain aspects.

FIG. 6 illustrates a network architecture that includes a wireless mesh network in accordance with certain aspects disclosed herein according to certain aspects.

FIGS. 7-9 is a sequence of drawings illustrating a first example of local anchor migration, where migration is initiated due to mobility of a mesh node according to certain aspects.

FIG. 10 illustrates a second example of local anchor migration, where migration is initiated due to mobility of a UE according to certain aspects.

FIG. 11 illustrates user plane protocol stacks that may be used in a wireless mesh network adapted according to certain aspects disclosed herein.

FIG. 12 is a block diagram illustrating an example of an apparatus employing a processing circuit that may be adapted according to certain aspects disclosed herein.

FIG. 13 is a flow chart of a method of wireless communication at a UE in accordance with certain aspects disclosed herein.

FIG. 14 is a diagram illustrating an example of a hardware implementation for an apparatus employing a processing employing a processing circuit adapted according to certain aspects disclosed herein.

FIG. 15 is a flow chart of a method of wireless communication at a local anchor in accordance with certain aspects disclosed herein.

FIG. 16 is a diagram illustrating an example of a hardware implementation for an apparatus employing a processing employing a processing circuit adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

### Overview

Certain aspects of the disclosure relate to a wireless device that supports a first mode of communication involving long-range communications with a scheduling entity of a wireless access network and a second mode of operation that involves short-range communications with one or more devices in a mesh network.

With the advent of ubiquitous network access and the provision of wireless communications capabilities in ever-increasing numbers of mobile phones and/or computing devices, there is continuous demand for improved access to serving networks. In some access technologies, a heterogeneous network environment may support traditional large cells (macrocells) and small cells, where a small cell may be provided through low-powered radio access nodes that operate in licensed and unlicensed spectrum and that can have a range of between 10 meters and 2 kilometers. In some implementations of 4G 3GPP technologies, including LTE-Advanced for example, Relay Nodes (RNs) may include low power base stations that can be deployed to provide enhanced coverage and capacity at various locations in a cell, including at cell edges, and in hotspots.

Prior relay solutions for cellular networks do not support multi-hop relaying, mesh topologies, relay-node mobility or transparency to the underlying air-interface technology on each link. Certain aspects disclosed herein relate to methods, systems and apparatus that enable wide area network (WAN) traffic to be relayed through a wireless mesh network that connects a plurality of low-power mobile devices using short-range communication methods. In one example, a subscriber station, or user equipment (UE), associated with a wide area radio access network (RAN) may communicate with a corresponding entity of the RAN, such as a scheduling entity, when traffic is relayed through a wireless mesh network.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

Certain aspects of the disclosure address networks of low-power devices used in communication systems. In some scenarios, these devices can be used in newer generations of radio access technologies (RATs), including in fifth generation (5G) and later networks, as well as in fourth generation (4G) and earlier networks. The configuration and operation of a 4G LTE network architecture is described herein by way example, and for the purpose of simplifying descriptions of certain aspects that may apply to multiple RATs. That is, scenarios of LTE networks are discussed by way of example, yet aspects of this disclosure are not limited to any particular radio access technology. Rather examples are used to help the reader understand aspects of the disclosure through the use of certain implementations and embodiments.

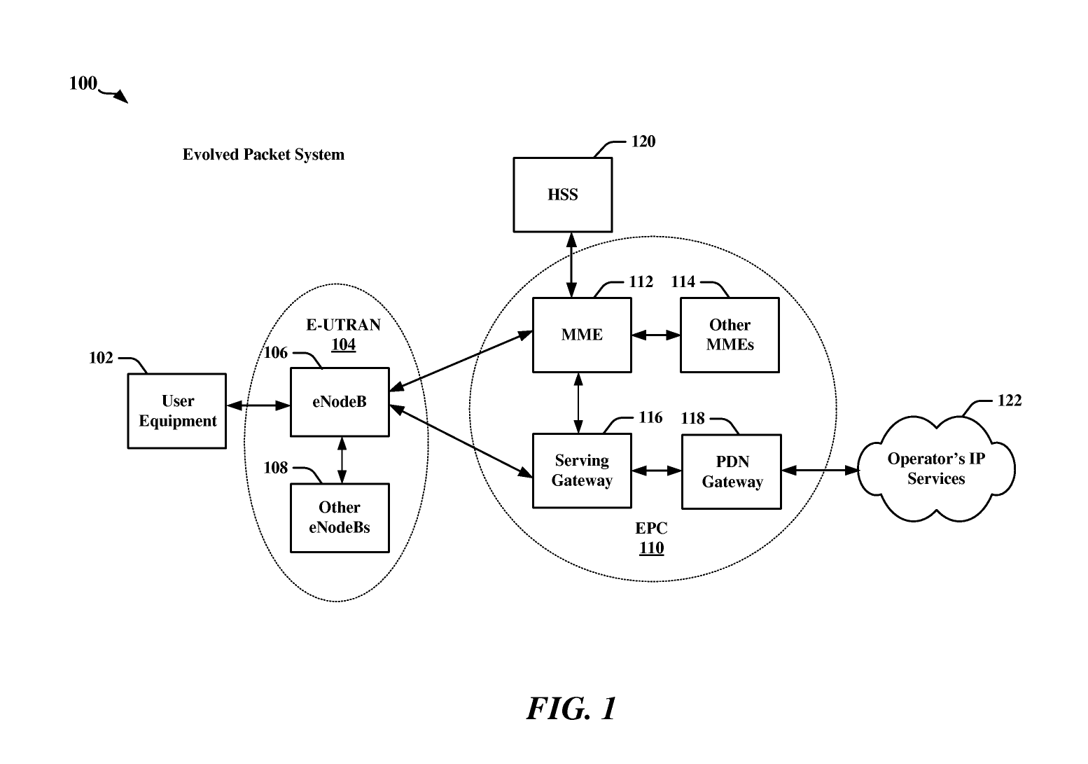

Now turning to the figures, FIG. 1 is a diagram illustrating certain features of a RAT using the example of an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS).

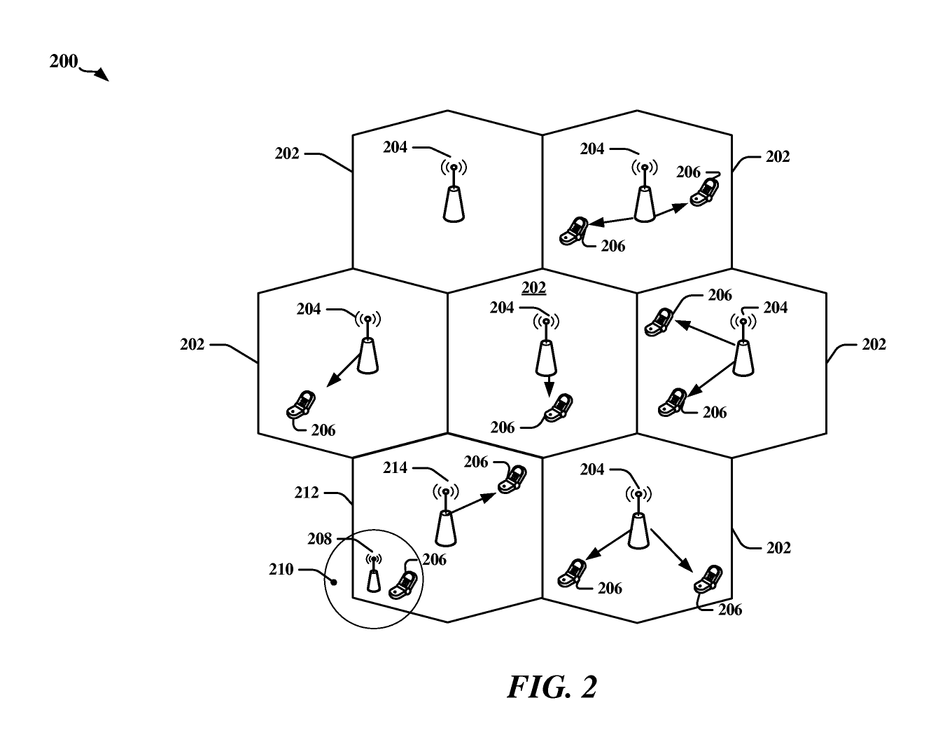

FIG. 2 is a diagram illustrating an example of an access network 200, which may provide access to subscriber services provided to subscriber stations (e.g., one or more of the UEs 206) through a core network operated a service provider associated with the subscriber stations. The access network 200 is divided into a number of cellular regions (cells) 202, 212. One or more lower power access points 208 may have cellular regions 210 that overlap with one or more of the cells 202, 212. The lower power access point 208 may be a referred to as femto cell, pico cell, micro cell, or remote radio head (RRH). Higher power, or macro access points 204, 214, are each assigned to a respective cell 202, 212 and are configured to provide access to a core network for the UEs 206 in the cells 202, 212. While no centralized controller is shown in this example of an access network 200, a centralized controller may be used in some configurations. The access points 204, 214 are responsible for all radio related functions including radio bearer control, admission control, mobility control, scheduling, security, and connectivity to the a serving gateway (see the serving gateway 116 in FIG. 1, for example).

The modulation and multiple access scheme employed by the access network 200 may vary depending on the particular telecommunications standard being deployed. Examples of telecommunication standards include LTE, Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations, where an air interface may be defined as the radio-based communication link between a mobile station and an active base station. Other examples of telecommunication standards include Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The access points 204, 214 may have multiple antennas supporting MIMO technology. The use of MIMO technology enables the access points 204, 214 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple LIES 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the access point 204, 214 to identify the source of each spatially precoded data stream.

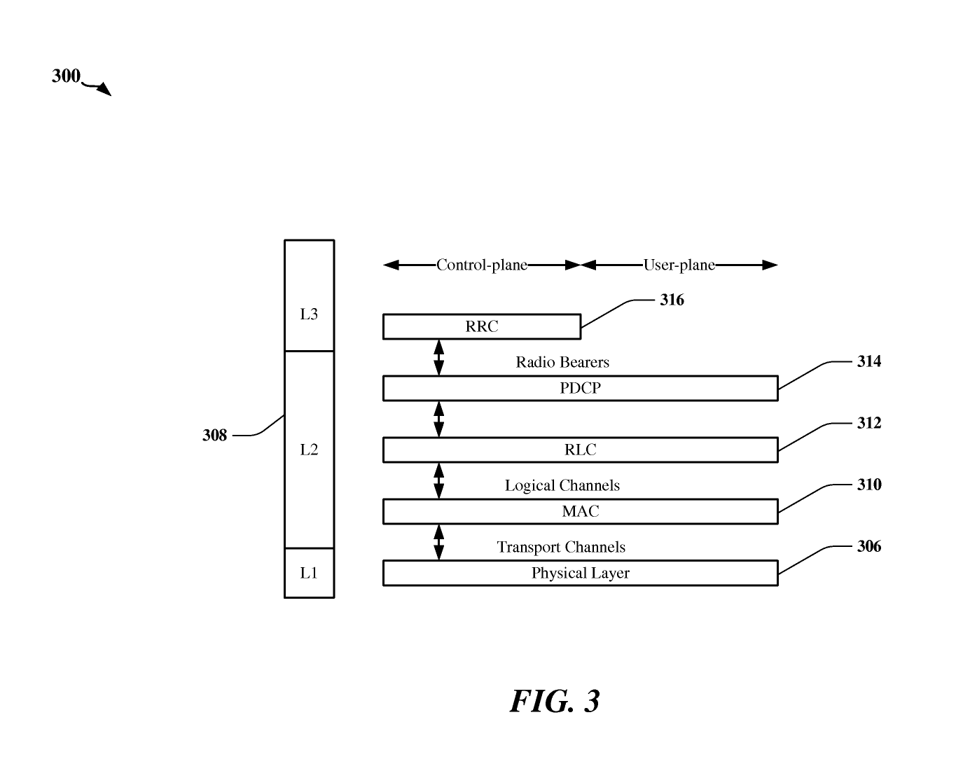

Networks, including packet-switched networks may be structured in multiple hierarchical protocol layers, where the lower protocol layers provide services to the upper layers and each layer is responsible for different tasks. FIG. 3 is a diagram 300 illustrating an example of a radio protocol architecture. In one example, a radio protocol architecture for a mobile device and a scheduling entity can be arranged in three layers: Layer 1, Layer 2, and Layer 3. Layer 1 (L1 layer) is the lowest layer and implements various physical layer signal processing functions. The L1 layer will be referred to herein as the physical layer 306. Layer 2 (L2 layer) 308 is above the physical layer 306 and is responsible for the link between the mobile device and the scheduling entity over the physical layer 306.

In a user plane, the L2 layer 308 includes a media access control (MAC) sublayer 310, a radio link control (RLC) sublayer 312, and a packet data convergence protocol (PDCP) sublayer 314, which are terminated at the mobile device on the network side. Although not shown, the mobile device may have several upper layers above the L2 layer 308 including a network layer (e.g., IP layer) that is terminated at the PDN gateway 118 on the network side, and an application layer that is terminated at the other end of the connection (e.g., far end UE, server, etc.).

The PDCP sublayer 314 provides multiplexing between different radio bearers and logical channels. The PDCP sublayer 314 also provides header compression for upper layer data packets to reduce radio transmission overhead, security by ciphering the data packets, and handover support for mobile devices between different scheduling entities. The RLC sublayer 312 provides segmentation and reassembly of upper layer data packets, retransmission of lost data packets, and reordering of data packets to compensate for out-of-order reception. The MAC sublayer 310 provides multiplexing between logical and transport channels. The MAC sublayer 310 is also responsible for allocating the various radio resources (e.g., resource blocks) in one cell among the mobile devices.

In the control plane, the radio protocol architecture for the mobile device and the scheduling entity is substantially the same for the physical layer (PRY) 306 and the L2 layer 308. The control plane also includes a radio resource control (RRC) sublayer 316 in Layer 3 (L3 layer). The RRC sublayer 316 is responsible for obtaining radio resources (i.e., radio bearers) and for configuring the lower layers using RRC signaling between the mobile device and the scheduling entity.

### Radio Link Setup in Wide Area Networks

A communication device, such as an access terminal, a UE, a mobile device, or the like, may establish a connection with a core network using one or more registration, attachment, provisioning and/or other procedures. In some examples, radio link setup may involve establishment of one or more radio bearers between an access node that provides access to a network and a communication device. Radio link setup typically includes a security activation exchange. A session bearer, which may be a logical bearer or logical channel, may then be established over the radio link and one or more services and/or communications may be established over the session bearer. The session bearer, services and/or communications may be secured by one or more security keys. As part of the session bearer setup, an authentication request and/or one or more key exchanges may take place. In some networks, keys may be derived by the communication device based on algorithms provided by one or more network entities.

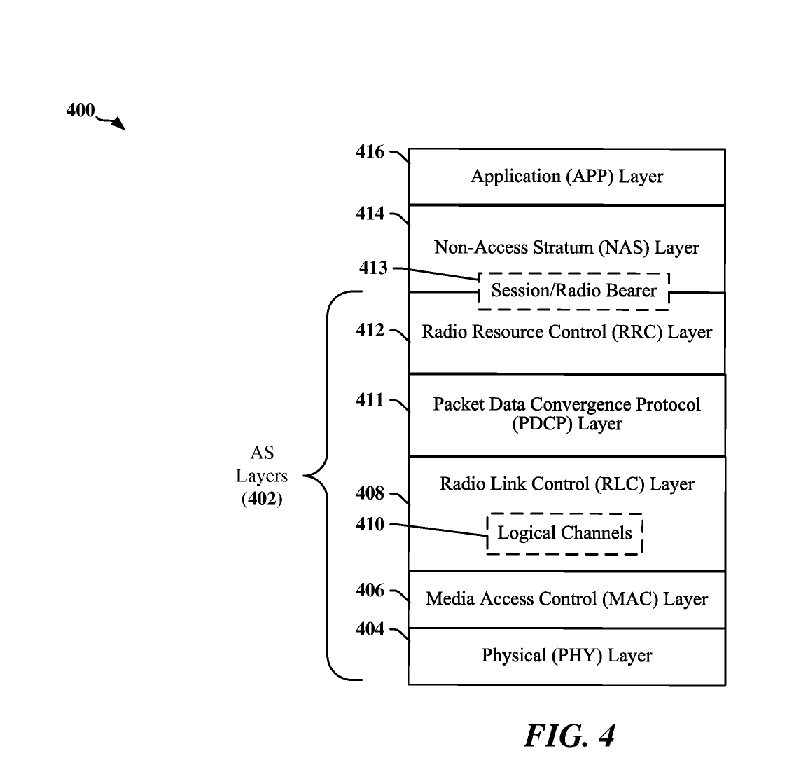

FIG. 4 illustrates an example of a protocol stack 400 that may be implemented in a communication device operating in a packet-switched network. In this example, the protocol stack 400 includes a PHY 404, a Media Access Control (MAC) Layer 406, a Radio Link Control (RLC) Layer 408, a Packet Data Convergence Protocol (PDCP) Layer 411, a RRC Layer 412, a non-access stratum (NAS) Layer 414, and an Application (APP) Layer 416. The layers below the NAS Layer 414 are often referred to as the Access Stratum (AS) Layer 402.

The RLC Layer 408 may include one or more channels 410. The RRC Layer 412 may implement various monitoring modes for the user equipment, including connected state and idle state. The NAS Layer 414 may maintain the communication device's mobility management context, packet data context and/or its IP addresses. Note that other layers may be present in the protocol stack 400 (e.g., above, below, and/or in between the illustrated layers), but have been omitted for the purpose of illustration. Radio/session bearers 413 may be established, for example at the RRC Layer 412 and/or NAS Layer 414. Initially, communications to and/or from a communication device may be transmitted (unprotected or unencrypted) over an unsecured common control channel. The NAS Layer 414 may be used by the communication device and an entity of the core network to generate security keys. After these security keys are established, communications including signaling, control messages, and/or user data may be transmitted over a Dedicated Control Channel (DCCH). NAS context may be reused at the time of Service Request, Attach Request and location tracking messages.

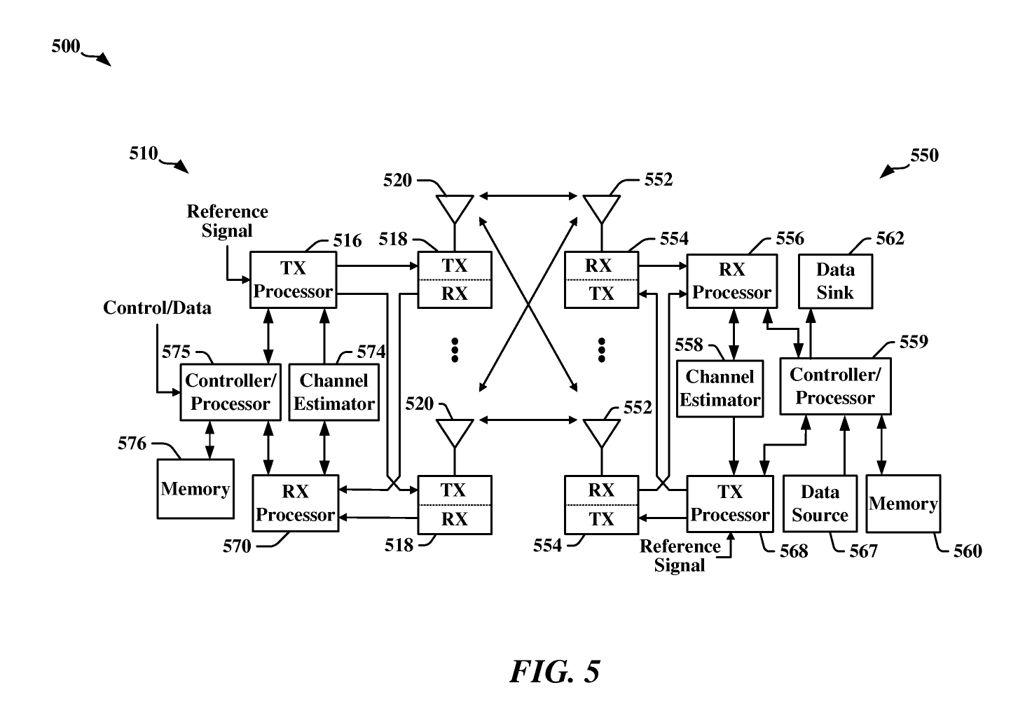

FIG. 5 is a block diagram 500 of a scheduling entity 510 in communication with a communication device 550 in an access network. The communication device 550 may be implemented in one or more processing circuits provided in a mobile device, a computing device, a UE, or the like. In certain RATs, the radio interface between the communication device 550 and the scheduling entity 510 may be referred to as the Uu. In the DL, upper layer packets from the core network are provided to a controller/processor 575. The controller/Processor 575 implements the functionality of the L2 layer. In the DL, the controller/processor 575 provides header compression, ciphering, packet segmentation and reordering, multiplexing between logical and transport channels, and radio resource allocations to the communication device 550 based on various priority metrics. The controller/processor 575 is also responsible for retransmission of lost packets, and signaling to the communication device 550.

The transmit (TX) processor 516 implements various signal processing functions for the L1 layer (i.e., physical layer). The signal processing functions include coding and interleaving to facilitate forward error correction (FEC) at the communication device 550 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. In one example, each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 574 may be used to determine the coding and modulation scheme, as well as for spatial processing. The channel estimate may be derived from a reference signal and/or channel condition feedback transmitted by the communication device 550. Each spatial stream is then provided to a different antenna 520 via a separate transmitter 518TX. Each transmitter 518TX modulates a radio frequency (RF) carrier with a respective spatial stream for transmission. The scheduling entity 510 may be implemented in one or more processing circuits.

At the communication device 550, each receiver 554RX receives a signal through its respective antenna 552. Each receiver 554RX recovers information modulated onto an RF carrier and provides the information to the receive (RX) processor 556. The RX processor 556 implements various signal processing functions of the L1 layer. The RX processor 556 performs spatial processing on the information to recover any spatial streams destined for the communication device 550. If multiple spatial streams are destined for the communication device 550, they may be combined by the RX processor 556 into a single OFDM symbol stream. The RX processor 556 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the scheduling entity 510. These soft decisions may be based on channel estimates computed by the channel estimator 558. The soft decisions are then decoded and deinterleaved to recover the data and control signals that were originally transmitted by the scheduling entity 510 on the physical channel. The data and control signals are then provided to the controller/processor 559.

The controller/processor 559 implements the L2 layer. The controller/processor can be associated with a memory 560 that stores program codes and data. The memory 560 may be referred to as a computer-readable medium. In the UL, the controller/processor 559 provides demultiplexing between transport and logical channels, packet reassembly, deciphering, header decompression, control signal processing to recover upper layer packets from the core network. The upper layer packets are then provided to a data sink 562, which represents all the protocol layers above the L2 layer. Various control signals may also be provided to the data sink 562 for L3 processing. The controller/processor 559 is also responsible for error detection using an acknowledgement (ACK) and/or negative acknowledgement (NACK) protocol.

In the UL, a data source 567 is used to provide upper layer packets to the controller/processor 559. The data source 567 represents all protocol layers above the L2 layer. Similar to the functionality described in connection with the DL transmission by the scheduling entity 510, the controller/processor 559 implements the L2 layer for the user plane and the control plane by providing header compression, ciphering, packet segmentation and reordering, and multiplexing between logical and transport channels based on radio resource allocations by the scheduling entity 510. The controller/processor 559 is also responsible for retransmission of lost packets, and signaling to the scheduling entity 510.

Channel estimates derived by a channel estimator 558 from a reference signal or feedback transmitted by the scheduling entity 510 may be used by the TX processor 568 to select the appropriate coding and modulation schemes, and to facilitate spatial processing. The spatial streams generated by the TX processor 568 are provided to different antenna 552 via separate transmitters 554TX. Each transmitter 554TX modulates an RF carrier with a respective spatial stream for transmission.

The UL transmission is processed at the scheduling entity 510 in a manner similar to that described in connection with the receiver function at the communication device 550. Each receiver 518RX receives a signal through its respective antenna 520. Each receiver 518RX recovers information modulated onto an RF carrier and provides the information to a RX processor 570. The RX processor 570 may implement the L1 layer.

The controller/processor 575 implements the L2 layer. The controller/processor 575 can be associated with a memory 576 that stores program codes and data. The memory 576 may be referred to as a computer-readable medium. In the UL, the control/processor 575 provides demultiplexing between transport and logical channels, packet reassembly, deciphering, header decompression, control signal processing to recover upper layer packets from the communication device 550. Upper layer packets from the controller/processor 575 may be provided to the core network. The controller/processor 575 is also responsible for error detection using an ACK and/or NACK protocol.

### Connectivity in a Heterogeneous Wireless Access Network

According to certain aspects disclosed herein, certain devices, methods, systems and apparatus may be adapted to enable WAN traffic to be relayed through a wireless mesh network that connects a plurality of low-power mobile devices using short range communication methods. In one example, a communication device, subscriber station, UE, or the like, that is associated with a wide area RAN may communicate with a corresponding entity of the RAN, such as a scheduling entity, when traffic is relayed through a wireless mesh network. Referring again to FIG. 2, a relay node such as the low power access point 208 may provide enhanced coverage in a small cell 210 that may be established within a large cell 212. The relay node may be connected to an access point 214 referred to as the Donor through a radio interface. The radio resources of the donor cell 212 may be shared between UEs 206 served directly by the Donor and the relay node. These types of relay solutions for cellular networks do not support multi-hop relaying, mesh topologies, relay-node mobility or transparency to the underlying air-interface, technology on each link. Conventional relay node solutions permit only a single-hop star topology, and do not support relay node mobility. In one example, LTE-WiFi tethering (mobile hotspot) implementations provide a single-hop relay solution, which is restricted to a closed subscriber group and confines mobility to the hotspot coverage area.

### Connectivity to a Wireless Access Network through a Routed Mesh Network

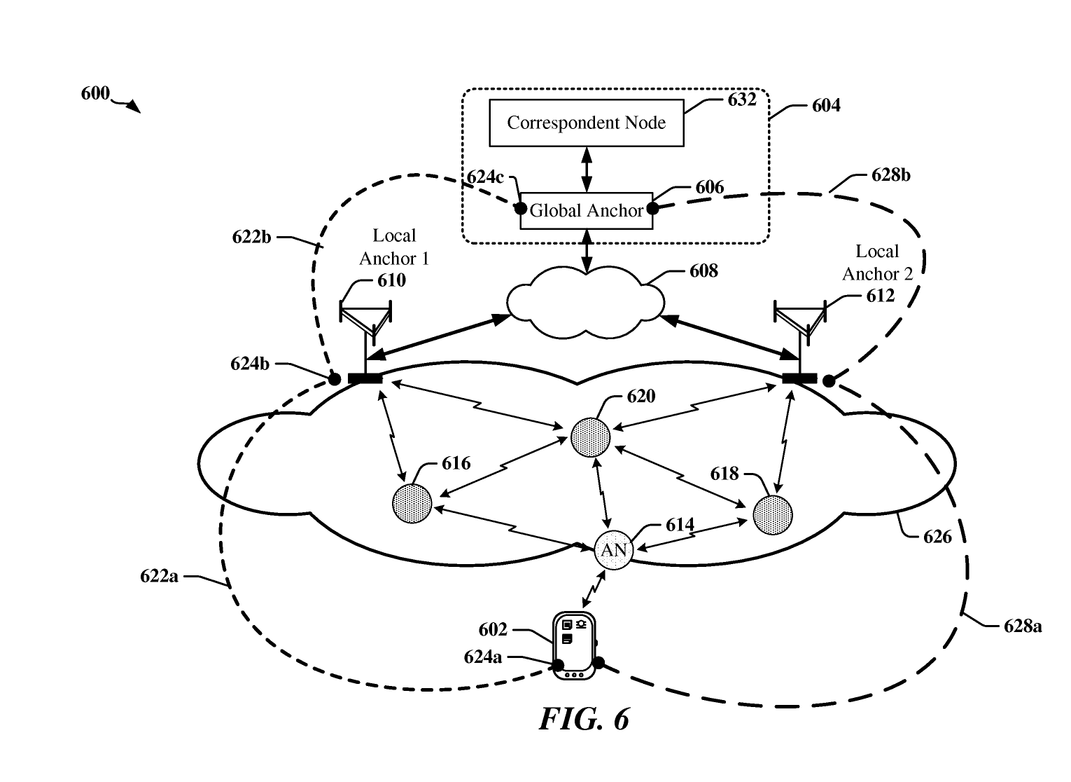

Certain aspects of a wireless mesh network will now be described with reference to FIGS. 6-10. The wireless mesh network may include one or more relay nodes. The wireless mesh network may employ an air-interface agnostic routing plane, and a routing protocol running on this routing plane may ensure reachability across the mesh and robustness to mesh topology changes. For example, the routing configuration of the wireless mesh network may track changes caused by mesh node mobility, and/or by power cycling events.

A wireless mesh network may connect mesh devices or mesh nodes devices that transmit at low power levels. A device considered to be a low-power device may have one or more features. For example, a device may be a low-power device when it transmits at a power level below a power level threshold that causes or results in its transmissions being ignored by a base station or other entity in a licensed radio access network. Low-power devices may be classified according to their maximum transmit power, which can limit communication range. For example, a low-power device may comply or be compatible with the IEEE 802.15.4 standard, which is typically used in networks that have a transmission range of less than 10 meters, and which defines a minimum power level of −3 dBm (0.5 mW), with transmission power being limited to 0 dBm (1 mW), 4 dBm (2.5 mW), or 20 dBm (100 mW) in various implementations. The determination of power-level may be based on an effective radiated power or equivalent radiated power (ERP), or an Effective Isotropic Radiated Power (EIRP). ERP may be understood as a standardized theoretical measurement obtained by calculating system losses and system gains. The EIRP may be employed to take beamforming and other output power concentrating factors into account. In one example, a low-power device may operate at a reduced transmitter power of 0 dBm.

FIG. 6 illustrates a network architecture 600 that includes a wireless mesh network 626 in accordance with certain aspects disclosed herein. The wireless mesh network 626 wirelessly interconnects a plurality of mesh nodes 614, 616, 618, 620 and, in the example, a pair of base stations that host a first local anchor 610 and a second local anchor 612 (these anchors may also be referred to serving and/or target anchors in some operational arrangements and/or scenarios as discussed herein). The base stations/local anchors 610, 612 may connect with a core network 604 using a backhaul network 608.

In conventional modes of operation, a UE 602 may establish a connection with a serving local anchor 610 and/or a non-serving local anchor 612 and may measure the channel conditions associated with both the serving local anchor 610 and the non-serving local anchor 612. The UE 602 and/or the serving local anchor 610 may initiate a reselection or handover procedure to cause the UE 602 to receive service from the previously non-serving local anchor 612 when certain criteria are met. The criteria are typically defined based on the radio access technology, configuration of the local anchor 610, 612, configuration of the UE 602, network provider preferences, and/or other factors and parameters. The criteria may relate to channel measurements, quality of service considerations, and other characteristics of the network.

According to certain aspects disclosed herein, the UE 602 may be adapted or configured to establish a connection over a wireless link with one or more of the mesh nodes 614, 616, 618, or 620. In the example and for the purposes of this description, the UE 602 connects with a node designated the attachment node (AN) 614. The UE 602 may attach to a routing plane associated with the wireless mesh network 626 using a routable address. In some instances, the mutable address is assigned to the UE 602 during attachment to the wireless mesh network 626 or the routing plane. In some instances, the UE 602 may use a predefined or static mutable address to attach to the wireless mesh network 626 or the routing plane.

The routing plane associated with the wireless mesh network 626, which may be referred to as the routing control plane, defines actions to be taken by a mesh node 614, 616, 618, or 620 when a packet is received from another mesh node 614, 616, 618, or 620. The routing plane describes and/or defines the topology of the wireless mesh network 626. Each mesh node 614, 616, 618, and 620 may maintain a routing table that determines the disposition of received packets. Packets addressed to the receiving mesh node 614, 616, 618, or 620 node may be processed by the receiving mesh node 614, 616, 618, or 620 node and provided to one or more applications resident on the receiving mesh node 614, 616, 618, or 620 node. Packets received at a mesh node 614, 616, 618, or 620 and addressed to a different mesh node 614, 616, 618, or 620 or other device may be forwarded through a transceiver or communication port in accordance with routing information maintained in a routing table stored at the mesh node 614, 616, 618, or 620. The routing table may be stored in a memory device of a processing circuit (see FIGS. 5, 12, 14, and 16 for example), and the routing table may be updated based on addressing information extracted from incoming packets, through control messages broadcast or otherwise propagated through the wireless mesh network 626, or from communications received from a managing mesh node 614, 616, 618, or 620 or the like.

The routing plane of a wireless mesh network 626 may directly or indirectly define pathways to external networks. For example, a packet transmitted by a UE 602 to a core network 604 may be encapsulated in one or more packets for transmission over the wireless mesh network 626. The packets may be addressed to a mesh node associated with the local anchor 610, and the routing plane may define one or more paths through the wireless mesh network 626 to the local anchor 610. In operation, each mesh node 614, 616, 618, and 620 transfers packets to the next mesh node 614, 616, 618, or 620 identified in a local routing table based on a destination address of the packet (i.e., the local anchor 610). In some instances, the destination address may be determined based on a tunneling protocol used to encapsulate packets transmitted by a UE 602 to a core network 604 before encapsulation for transfer through the wireless mesh network 626.

The UE 602 may move through a geographical region covered by the wireless mesh network 626, and the UE 602 may establish a connection with a different attachment point 616, 618, or 620 as desired, or based on communication channel conditions. The UE 602 may retain its routable address after connecting to a different attachment point 616, 618, or 620, such that the routing protocol can ensure session continuity.

The wireless mesh network 626 may interface with an operator's backhaul network 608 through one or more local anchors 610, 612. The one or more local anchors may be included in the routing plane of the wireless mesh network 626, and shield the backhaul from the dynamics of the wireless mesh network 626. The UE 602 may sustain a bearer with a global anchor 606 in the core network 604. The bearer is established through one of the local anchors 610, 612. Through this bearer, the UE 602 can exchange data and control information (bearer traffic) with outside hosts. In some instances, it may be desirable for the UE 602 to change its associated local anchor 610, 612 as a result of changes in the routing plane. In one example, the physical geometry between local anchors 610, 612 and/or the mesh nodes 614, 616, 618, and 620 may change due to mobility and/or power cycling of one or more mesh nodes 610, 612, 614, 616, 618. In another example, the UE 802 may be in motion and may change its attachment point (attachment node 614) to the wireless mesh network 626.

According to certain aspects, a mobility protocol may be employed to execute anchor migration. A mobility procedure may be provided to manage, control and/or initiate anchor evaluation and selection procedures used by the mobility protocol based on measurements derived from the routing protocol. In this manner, node mobility in the wireless mesh network 626 may remain properly separated from the operator's backhaul network 608 and core network 604, and the optimal attachment point for the UE 802 to the operator's network may be guaranteed. In some aspects, existing handover procedures can be used in compliance and/or in conjunction with the mobility protocol.

According to certain aspects, the UE 602 maintains a routable address in the routing plane associated with the wireless mesh network 626. The routable address may allow the UE 602 to use the routing plane to exchange packets with one or more local anchors 610, 612 that are connected to the wireless mesh network 626. Mesh nodes 614, 616, 618, and 620 and local anchors 610, 612 may be adapted to support a routing protocol, which ensures reachability and robustness as the mesh topology changes. In one example, topology changes include changes of attachment node 614. The UE 602 may change its current attachment point (attachment node 614) to the wireless mesh network 626 in a break-before-make or make-before-break manner. Upon announcement of its routing address during attachment, the routing protocol may reestablish a path for the UE 602 and thereby ensure session continuity.

The UE 602 may exchange packets with an outside correspondent node 632 through the cellular core network 604. These packets are communicated through a bearer established between the UE 602 and a Global Anchor 606, which resides in the core network. The bearer can be realized using a tunnel through the wireless mesh network 626 and/or the backhaul network 608. The tunnel may be relayed by a forwarding function located at the serving local anchor 610. The serving local anchor 610 ensures separation of the wireless mesh network 626 and the backhaul network 608, and the serving local anchor 610 may shield the backhaul network 608 and the core network 604 from topology changes in the wireless mesh network 626.

Certain aspects disclosed herein relate to migration of the bearer associated with the UE 602 from the serving local anchor 610 to a target local anchor 612. Bearer migration between local anchors 610, 612 is commonly known in cellular systems and may be generally referred to as handover. A handover is typically exercised by a mobility protocol in response to a change in channel conditions between the UE 602 and a serving base station, where the serving base station hosts the local anchor 610. Mobility protocols typically rely on periodic and accurate measurements of the UE-to-base station link quality to serving base station and to target base stations, and this information may be used to select a target local anchor 612.

Generally, the conventional handover procedure cannot be applied when a wireless mesh network 626 is used to connect the UE 602. First, the UE 602 may not maintain a direct link with any of the local anchors 610, 612. Second, even if a direct link is maintained, the majority of traffic may be routed across multiple mesh nodes 614, 616, 618, 620 instead of directly to a local anchor 610, 612. Hence, the link quality between UE 602 and local anchor may be of little value in determining and selecting the optimal local anchor 610, 612. Additionally, anchor migration may be indicated for a larger number of reasons including, for example, variation of the channel conditions between mesh nodes 614, 618, 618, 620 through fading, mesh-node mobility, or power cycling of mesh nodes. Variations in the channel conditions within the wireless mesh network 626 can affect transport mechanisms of the wireless mesh network 626. Anchor migration may also be indicated when the UE 602 changes the point of attachment to the wireless mesh network 626.

According to certain aspects, metrics derived from the routing protocol on the wireless mesh network 626 may be used for the evaluation and selection of local anchors 610, 612. Since these metrics enable comparison and selection among multiple routing paths between the same end-point pair, they can also serve as an appropriate tool to compare and select among routing paths pertaining to different end-point pairs. Anchor migration procedures may include UE-controlled anchor migration, network-based UE-assisted anchor migration, and/or network-controlled anchor migration.

### UE-Controlled Anchor Migration

The UE 602 may determine the need or desirability of a change of local anchor 610, 612 and/or may initiate the handover or reselection procedure used to effect a change in local anchor 610, 612. Continuing with the example depicted in FIG. 6, in which the UE 602 is attached through a node 614 to the wireless mesh network 626 and the UE 602 maintains a routable IP address on the routing plane of the wireless mesh network 626. The UE 602 may maintain an association with a serving local anchor 610 and may hold the corresponding information in a cache. The UE 602 may maintain a tunnel end-point 624a to this serving local anchor 610. A corresponding tunnel (represented by the virtual connection 622a) is terminated and/or relayed at a relay and/or tunnel end-point 624b in the serving local anchor 610. The tunnel may be relayed and/or extended to a tunnel end-point 624c at the Global Anchor 606 (by virtue of virtual connection 622b). The tunnel or tunnels allow the UE 602 to securely exchange packets with the global anchor 606. The UE 602 may be adapted or configured to participate in the routing protocol used by the wireless mesh network 626.

The UE 602 may dynamically obtain a routable address for the wireless mesh network 626 during an attachment procedure. In some instances, the routable address is statically defined at the UE 602, and/or may be determinable based on a unique identifier associated with the UE 602, such as a MAC address or other unique address corresponding to the networking protocols used in the wireless mesh network 626.

The UE 602 may be configured by the serving local anchor 610 to evaluate routing metrics for a list of potential tar et local anchors 612. The list may include entries provided by the serving local anchor 610, the core network 604 and/or by the routing protocol. The UE 602 may be configured with threshold values and/or algorithms that may be used to evaluate and compare path metrics derived from the routine metrics.

In operation, the UE 602 may periodically receive routing protocol messages and the UE 602 may evaluate path metrics for the paths to the serving local anchor 610 and/or the target local anchors 612. In one example, the UE 602 may compare the path metrics, and may apply algorithms and thresholds provided by the serving local anchor 610.

Based on an evaluation of the path metrics, the UE 602 may select a target local anchor 612. The UE 602 may then send an anchor-migration request message to either the serving anchor 610 or the selected target local anchor 612.

Upon receipt of an anchor-migration request message, a local anchor 610, 612 may initiate an anchor-migration procedure for the UE 602 and, may inform the global anchor 606 to switch packet delivery to the new local anchor 612.

The UE 602 may receive a reconfiguration message, and may respond by changing its association and corresponding state to that of the target local anchor 612. The UE 602 may further change the remote tunnel end-point 624b using, for example, the address of the selected target local anchor 612.

The UE 602 may exchange packets with the global anchor 606 through a new tunnel 628a, 628b established with the selected target local anchor 612, and the selected target anchor 612 may then become the new serving local anchor. The new serving local anchor 612 may configure the UE 602 to provide and a list of target local anchors from, or about which the UE 602 should obtain routing metrics.

In some instances, the UE 602 may not participate in the routing protocol of the wireless mesh network 626. In such instances, the UE 602 may periodically send a request to the attachment node 614 to obtain path metrics for the serving and the target local anchors 610, 612. The attachment node 614 may evaluate these metrics based on the routing protocol and forward the metrics and/or an evaluation of the metrics to the UE 602.

### Network-Based, UE-Assisted Anchor Migration

The radio access network associated with a UE 602 and/or the core network 604 may determine the need or desirability of a change of local anchor 610, 612 and/or may initiate the handover or reselection procedure used to effect a change in local anchor 610, 612. Continuing with the example depicted in FIG. 6, where the UE 602 is attached through a node 614 to the wireless mesh network 626 and the UE 602 maintains a routable IP address on the routing plane of the wireless mesh network 626. The UE 602 may maintain an association with a serving local anchor 610 and may hold the corresponding information in a cache. The UE 602 may maintain a tunnel end-point 624a to this serving local anchor 610. A corresponding tunnel (represented by the virtual connection 622a) is terminated and/or relayed at a relay and/or tunnel end-point 624b in the serving local anchor 610. The tunnel represented by the virtual connection 622b may be relayed and/or extended to a tunnel end-point 624c at the Global Anchor 606. The tunnel or tunnels allow the UE 602 to exchange packets with the global anchor 606. The UE 602 may be adapted or configured to participate in the routing protocol used by the wireless mesh network 626.

The UE 602 may be configured by the serving local anchor 610 to evaluate routing metrics for a list of potential target local anchors 612. The list may include entries provided by the serving local anchor 610, the core network 604 and/or by the routing protocol. The UE 602 may be configured with threshold values and/or algorithms that may be used to evaluate and compare path metrics derived from the routing metrics.

In operation, the UE 602 may periodically receive routing protocol messages and the UE 602 may evaluate path metrics for the paths to the serving local anchor 610 and/or the target local anchors 612. In one example, the UE 602 may compare the path metrics and may apply algorithms and thresholds provided by the serving local anchor 610.

The UE 602 may send the path metrics to the serving local anchor 610. The path metrics may be sent periodically and/or in response to a trigger condition that may be based on the path metrics, for example. The trigger condition may be generated based on thresholds or algorithms configured by the serving local anchor 610.

The serving local anchor 610 may compare the path metrics for various local anchors 610, 612. Based on such comparison, the serving local anchor 610 may select a target local anchor 612. The serving local anchor 610 may send an anchor-migration request message to the selected target local anchor 612, and the serving local anchor 610 may receive a confirmation message in response.

The UE 602 may receive a reconfiguration message, and may change its association and corresponding state to that of the target local anchor 612 in response. The UE 602 may further change the remote tunnel end-point 624b using, for example, the address of the selected target local anchor 612.

The UE 602 may exchange packets with the global anchor 606 through a new tunnel established with the selected target local anchor 612, and the selected target anchor 612 may then become the new serving local anchor. The new serving local anchor 612 may configure the UE 602 to obtain routing metrics on a list of target local anchors.

In some instances, the UE 602 may not participate in the routing protocol of the wireless mesh network 626. In such instances, the UE 602 may periodically send a request to the attachment node 614 to obtain path metrics for the serving and the target local anchors 610, 612. The attachment node 614 may evaluate these metrics based on the routing protocol and forward the metrics and/or an evaluation of the metrics to the UE 602.

### Network-Controlled Anchor Migration

The radio access network associated with a UE 602 and/or the core network 604 may determine the need or desirability of a change of local anchor 610, 612 and/or may initiate the handover or reselection procedure used to effect a change in local anchor 610, 612. Continuing with the example depicted in FIG. 6, where the UE 602 is attached through a node 614 to the wireless mesh network 626 and the UE 602 maintains a routable IP address on the routing plane of the wireless mesh network 626. The UE 602 may maintain an association with a serving local anchor 610 and may hold the corresponding information in a cache. The UE 602 may maintain a tunnel end-point 624a to this serving local anchor 610. A corresponding tunnel (represented by the virtual connection 622a) is terminated and/or relayed at a relay and/or tunnel end-point 624b in the serving local anchor 610. The tunnel represented by the virtual connection 622b may be relayed and/or extended to a tunnel end-point 624c at the Global Anchor 606. The tunnel or tunnels allow the UE 602 to exchange packets with the global anchor 606. The UE 602 may be adapted or configured to participate in the routing protocol used by the wireless mesh network 626.

The serving local anchor 610 may send a request to evaluate routing metrics for the UE 602 to potential target local anchors 612. The target local anchor 612 may also be requested to derive corresponding path metrics and forward these path metrics to the serving local anchor 610. The request may further contain threshold values or algorithms to evaluate and compare path metrics. The target local anchor 612 may derive and/or evaluate routing metrics based on protocol messages. For example, the target local anchor 612 may periodically receive routing protocol messages associated with the address of the UE 602 and the target local anchor 612 may derive path metrics for the UE 602 based on such messages.

A target local anchor 612 may forward path metrics to the serving local anchor 610. The path metrics may be forwarded periodically and/or in response to a trigger condition that may be based on the path metrics, for example. The trigger condition may be generated based on thresholds or algorithms provided by the serving local anchor 610.

The serving local anchor 610 may compare the path metrics for various local anchors 610, 612. Based on such comparison, the serving local anchor 610 may select a target local anchor 612. The serving local anchor 610 may send an anchor-migration request message to the selected target local anchor 612, and the serving local anchor 610 may receive a confirmation message in response.

The UE 602 may receive a reconfiguration message, and may change its association and the corresponding state to that of the target local anchor 612 in response. The UE 602 may further change the remote tunnel end-point 624b using, for example, the address of the selected target local anchor 612.

The UE 602 may exchange packets with the global anchor 606 through a new tunnel established with the selected target local anchor 612, and the selected target anchor 612 may then become the new serving local anchor. The new serving local anchor 612 may configure the UE 602 to obtain routing metrics on a list of target local anchors.

In some instances, the UE 602 may not participate in the routing protocol of the wireless mesh network 626. In such instances, the UE 602 may periodically send a request to the attachment node 614 to obtain path metrics for the serving and the target local anchors 610, 612. The attachment node 614 may evaluate these metrics based on the routing protocol and forward the metrics and/or an evaluation of the metrics to the UE 602.

### Examples of Anchor Migration

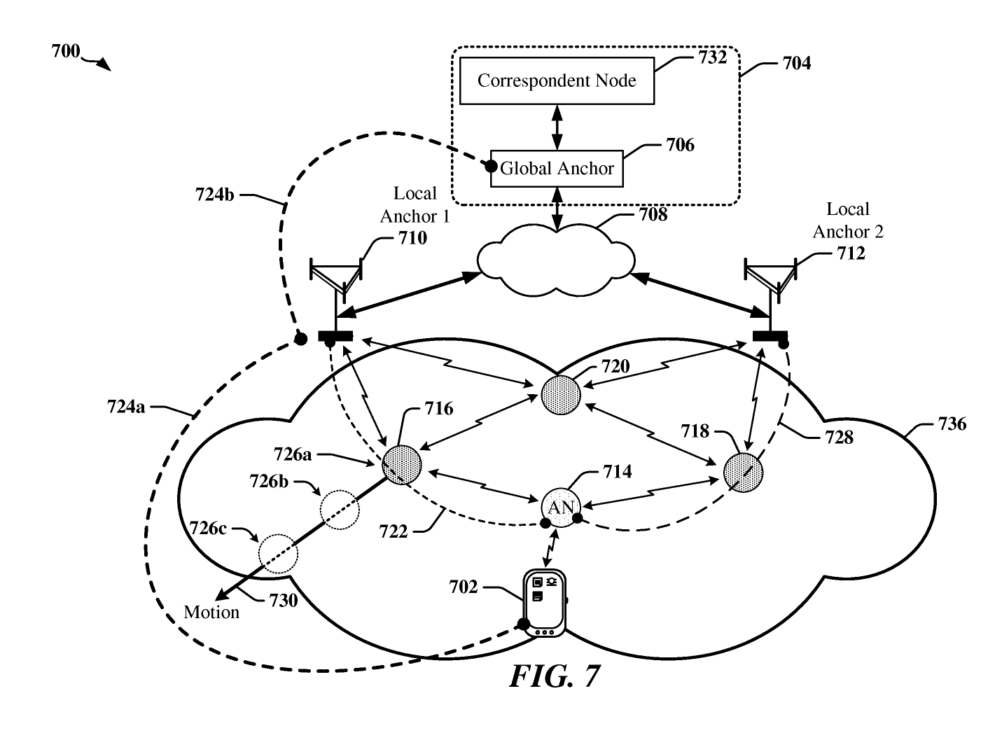

FIGS. 7-9 illustrate one example of local anchor migration. In this example, local anchor migration is initiated due to mobility of a mesh node 716. FIG. 7 illustrates a network configuration 700 at an initial point in time. The network configuration may be the same or similar to the network configuration in FIG. 6. A UE 702 is attached to one node 714 of a wireless mesh network 736, which enables the UE 702 to exchange packets with a first local anchor 710 and/or a second local anchor 712 through the routing plane of the mesh network. The local anchors 710, 712 may be connected to the mesh network. The UE 702 maintains a bearer with the Global Anchor 706 through the first local anchor 710, which is the serving anchor at this time. According to certain aspects disclosed herein, the bearer may be maintained using a virtual path 724a between the UE 702 and the first local anchor 710. The virtual path 724a may be provided using a tunneling protocol. The virtual path 724a may be extended through a virtual path 724b provided between the first local anchor 710 and the Global Anchor 706. The virtual path 724a between the UE 702 and the first local anchor 710 may be implemented as a dynamically changeable physical path through the wireless mesh network 736.

The UE 702 and the serving local anchor 710 may exchange data and control information along a first routing path 722 established through the routing plane. The routing plane may define a second routing path 728 from the UE 702 to a non-serving local anchor 712, through a forwarding third mesh node 718. The second routing path 728 may be substantially idle. The first routing path 722 extends from the attachment node 714 through a second mesh node 716 and then to the serving local anchor 710. In accordance with protocols defined by the routing plane, the second mesh node 716 may forward packets transmitted by the UE 702 to the serving local anchor 710 and may forward packets transmitted to the UE 702 by the serving local anchor 710 (i.e., mesh node 716 is an intermediate node in the virtual path 724a).

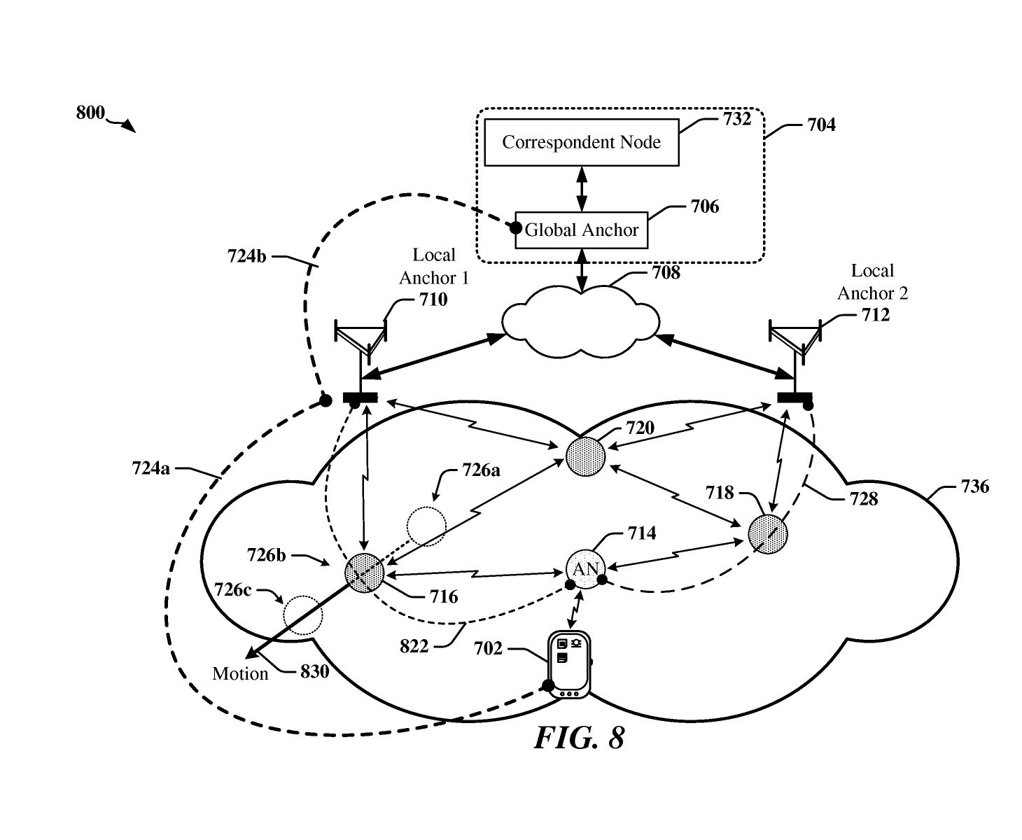

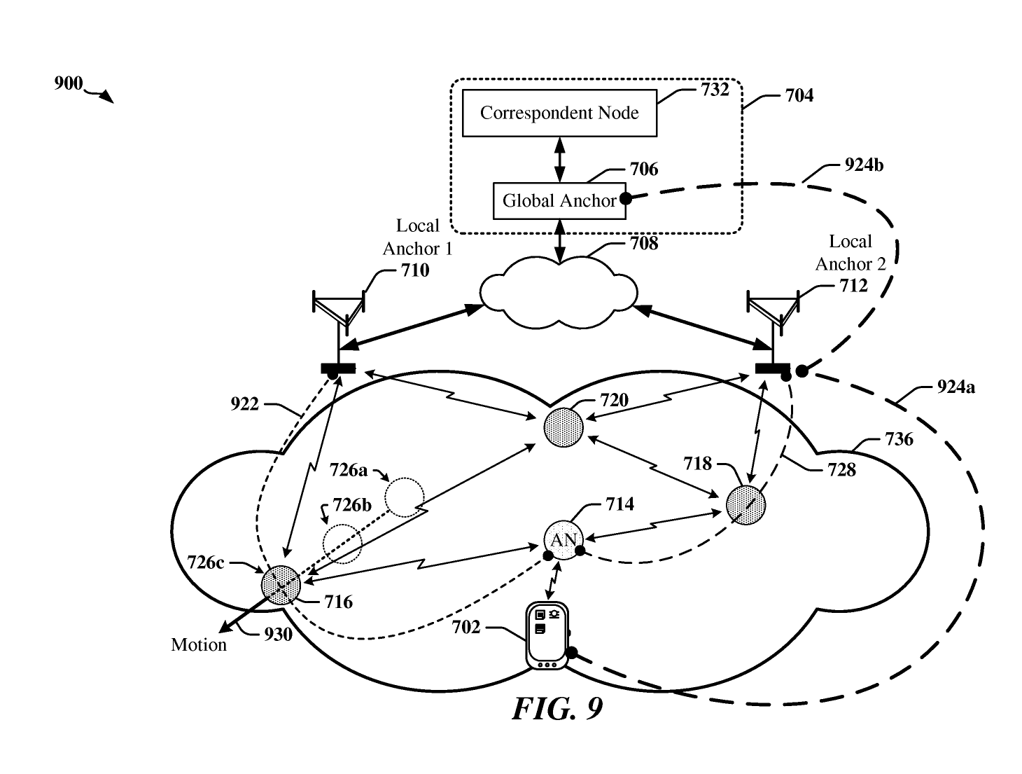

In the example illustrated by FIGS. 7-9, the second mesh node 716 may be in motion and traveling between successive physical locations 726a, 726b, 726c along a direction of motion indicated by the arrow 730. The motion of the second mesh node 716 may increase the physical distances between the second mesh node 716 and both the attachment node 714 and the serving local anchor 710. FIG. 8 illustrates a network configuration 800 after a first period of movement and FIG. 9 illustrates a network configuration 900 at a time after further movement has occurred. In FIG. 7, the second mesh node is at a first physical location 726a, in FIG. 8 the second mesh node has moved to a second physical location 726b, and in FIG. 9 the second mesh node has moved to a third physical location 726.

The first routing path 722 illustrated in FIG. 7 may represent one or more physical transmission paths. These paths may be shorter in length than the physical transmission paths corresponding to the first routing path 822 in FIG. 8, due to motion of the second mesh node 716. The first routing path 822 illustrated in FIG. 8 may represent one or more physical transmission paths that are shorter in length than the physical transmission paths corresponding to the first routing path 922 in FIG. 9, due to motion of the second mesh node 716. As the physical transmission paths corresponding to the first routing path 722, 822, 922 increase in length, the first routing path 722, 822, 922 may become less favorable than the second routing path 728. According to certain aspects disclosed herein, anchor migration may be performed when the second routing path 728 presents a preferable option for carrying traffic through the non-serving access point (i.e. local anchor 712) to the core network 704. The bearer established between the UE 702 and the Global Anchor 706 may be migrated as part of the anchor migration. In FIG. 9, bearer migration has been effected, and new tunnels 924a, 924b have been established between the UE 702, the second local anchor 712, and the Global Anchor 706.

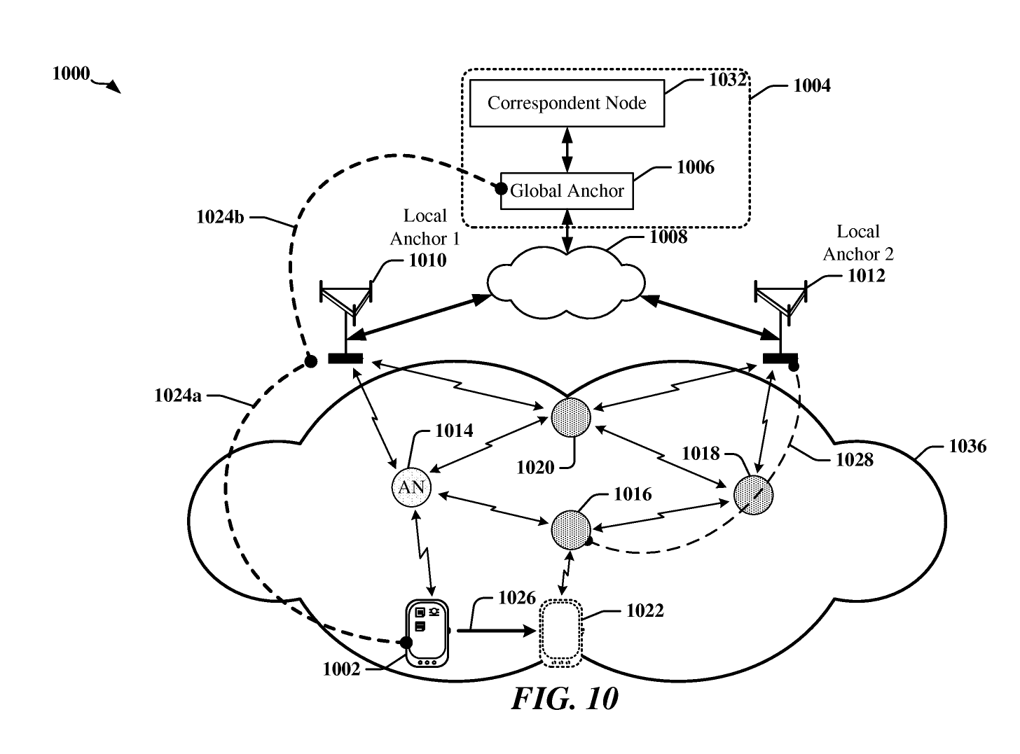

FIG. 10 illustrates a changing network configuration 1000 that illustrates another example of local anchor migration. In this example, a UE 1002 is initially attached to one node 1014 of a wireless mesh network, which enables the UE 1002 to exchange packets with a first local anchor 1010 and/or a second local anchor 1012 through the routing plane of the mesh network. The local anchors 1010, 1012 may be connected to the mesh network. The UE 1002 maintains a bearer with the Global Anchor 1006 through the first local anchor 1010, which is the initial serving anchor.

In this example, the UE 1002 may be in motion and traveling toward a physical location 1022 along a direction of motion indicated by the arrow 1026. Upon reaching the physical location 1022, the UE 1002 may change its point of attachment to the wireless mesh network from a current attachment node 1014 to another attachment node, such as a second mesh node 1016. Having reattached to the wireless mesh network through the second mesh node 1016, it may be determined that a routing path 1028 through a third mesh node 1018 may provide a more favorable connection to the second local anchor 1012 than alternative paths to the first local anchor 1010 through other mesh nodes 1014, 1020. According to certain aspects disclosed herein, anchor migration may be performed when the first routing path 1028 presents a preferable option for carrying traffic to an access point (i.e. local anchors 1010 or 1012) to the core network 1004. The bearer established between the UE 1002 and the Global Anchor 1006 may be migrated as part of the anchor migration.

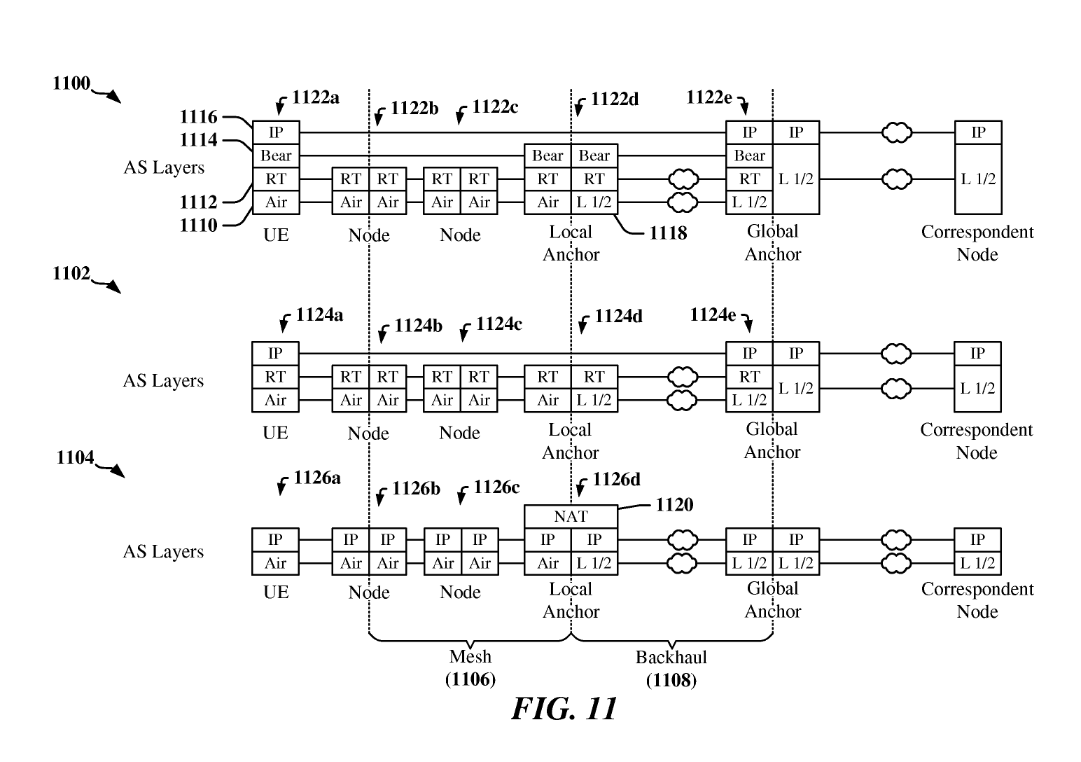

With further reference to FIG. 6, FIG. 11 includes examples 1100, 1102, 1104 of user plane protocol stacks that may be used in a wireless mesh network 626 adapted according to certain aspects disclosed herein. Certain protocol stacks 1122a-1122e, 1124a-1124e, 1126a-1126e include an air interface physical layer (the “Air” layer) 1110 that provides data transport services to higher layers. The physical layer may perform a variety of services, including error detection on transport channels, frequency and time synchronization, radio characteristics measurements, antenna processing, RF processing, and so on. The air interface layer 1110 is provided as the bottom layer of certain protocol stacks 1122a-1122e, 1124a-1124e, 1126a-1126e. Wireless links within the mesh network may use the same or different air interfaces. For example, a wireless mesh network may be implemented using some combination of radio access technologies, including 3G, 4G, 5G and/or other cellular networking technologies, WiFi, Bluetooth, other wireless networking, ad hoc networking, and/or near field communications technologies.

Certain protocol stacks 1122a-1122e, 1124a-1124e may also include a routing plane (the RT layer) 1112. In one example, this layer can include and/or be supplemented by an IP layer and be provided to support an address space with a locally unique address for each node in the wireless mesh network 626. The nodes of the wireless mesh network 626 may include mesh nodes 614, 616, 618, 620, local anchors 610, 612 and one or more UEs 602 and the locally unique address may ensure reachability across the wireless mesh network 626. Examples of routing planes 1112 may include IP, IEEE 802.1 and/or any other suitable forwarding mechanism that can be adapted in accordance with certain aspects disclosed herein.

In one example 1100, the user plane supports a separate bearer layer (Bear) 1114 from a UE 602 to the Global Anchor 606. The bearer layer 1114 may be relayed at the Local Anchor 610, 612. This bearer layer 1114 may be realized using a tunneling protocol such as Generic Routing Encapsulation (GRE) and/or Generic Tunneling Protocol (GTP) User Plane (GTP-U) tunneling. IP packets may be exchanged through the bearer layer 1114.

In another example 1102, the bearer layer 1114 may be realized using a tunneling protocol provided as an IP tunnel on top of the forwarding plane. In this case, the local anchor may switch the bearer via an IP router function.

In another example 1104, a fiat IP routing scheme is employed in the wireless mesh network. IP routing may be configured to manage routing within the mesh domain 1106 between a UE 602 and a local anchor 610, 612, as well as on the backhaul domain 1108 that connects local anchors 610, 612 and the global anchor 606. In this example, the local anchor 610, 612 may reserve a separate IP address in the backhaul space for each UE 602 and may apply a Network Address Translation (NAT) to translate between the mesh address of the UE 602 and a corresponding address reserved for the UE 602 on the backhaul domain 1108 when forwarding packets between both domains 1106, 1108. In this manner, the notion of a per-UE bearer can be preserved.

In each of the examples 1100, 1102, 1104 in FIG. 11, the local anchor 610, 612 maintains bearer-specific state information. The state information may enable the local anchor 610, 612 to map packets to a bearer, look up the corresponding destination on the routing plane, and send the packet to the appropriate destination by either adding an appropriate packet header or rewriting an existing packing header.

UE-specific state is typically established via signaling. During anchor migration this UE-specific state is transferred from the serving local anchor 610 to the target local anchor 612. At the same time, the global anchor 606 is updated and may switch packet forwarding from the serving local anchor 610 to the selected target local anchor 612 after anchor migration. Conventional anchor support procedures may be adapted for use with anchor migration initiated while a UE 602 is connected through a wireless mesh network 626. For example, Mobile IPv4, Mobile IPv6, Proxy Mobile IP and/or GTP-based mobility of 3GPP's System Architecture Evolution (SAE) procedures may be adapted of use with a wireless mesh network 626.

### Evaluation of Path Metrics

According to certain aspects disclosed herein, decisions to select and/or migrate between local anchors 610, 612 for a mesh-connected UE 602 may be based on the evaluation of a path metric. In some instances, this path metric can be derived from metrics delivered by the routing protocol. Accordingly, the path metric can include a hop count or any other path-related property, such as an aggregated path cost or path weight, which includes consideration of all links on that path. In some instances, the path metric may be derived from individual link metrics such as signal strength, signal-to-noise ratio (SNR), signal-to-interference ratio (SINR), interference, throughput, capacity latency or load. In one example, a path metric can be derived from the minimum signal strength, SNR, SINR, throughput or capacity along the links of a path, for example. The path metric can further be represented by an explicit list of link metrics for each link on the path.

In many examples, a path of concern runs between UE 602 and local anchor 610, 612 and the path metric used for local anchor evaluation may include a fraction of this path. The paths depicted in FIG. 6, for example, may include only the links from a local anchor 610, 612 to the attachment node 614, and the paths may not include the link between UE 602 and the attachment node 614. In some instances, evaluations of path metrics based on such reduced paths may be sufficient. For example, the link between the UE 702 and mesh attachment point 714 in FIGS. 7-9 is the same for all paths between the UE 702 and the local anchors 710, 712 in the mesh. Including this attachment link into the path metrics may therefore have limited or no effect on the comparison of paths to the different local anchors 710, 712, and the attachment link may be excluded.

In some instances, a local anchor 610, 612 may be implemented on an SAE eNB 106 (see FIG. 1), and a global anchor 606 may be implemented on anode in the EPC 110 such as the serving gateway 116 or PDN Gateway 118. In this case, the X2 and S1 interfaces may be used for the migration of the local anchor. In other instances, the local anchor function is represented by a Mobility Anchor Gateways and the global anchor function by a Local Mobility Anchor as defined by the Proxy Mobile IP (PMIP) is a network-based mobility management protocol by Proxy Mobility IP by the Internet Engineering Task Force (IETF®).

### Examples Involving a Processing Circuit or System

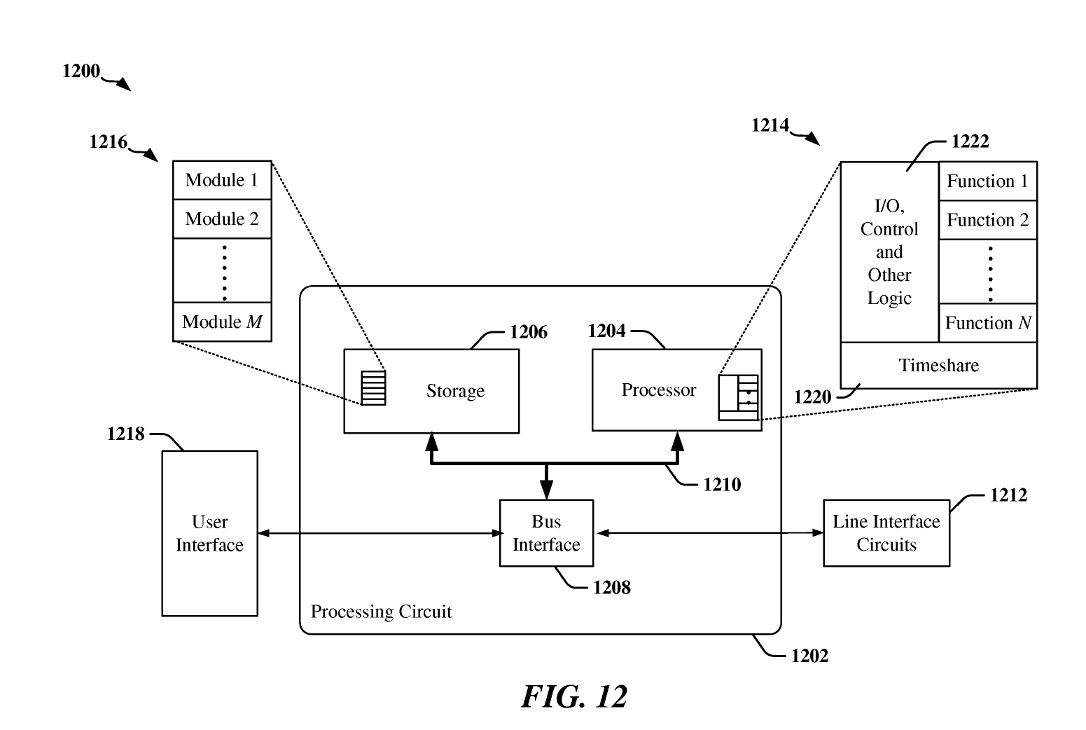

FIG. 12 is a conceptual diagram 1200 illustrating a simplified example of a hardware implementation for an apparatus employing a processing circuit 1202 that may be configured to perform one or more functions disclosed herein. In one example, the scheduling entity 510 illustrated in FIG. 5 may include one or more instances of the processing circuit 1202. In another example, the communication device 550 illustrated in FIG. 5 may include one or more instances of the processing circuit 1202.

In accordance with various aspects of the disclosure, an element, or any portion of an element, or any combination of elements as disclosed herein may be implemented using the processing circuit 1202. The processing circuit 1202 may include one or more processors 1204 that are controlled by some combination of hardware and software modules. Examples of processors 1204 include microprocessors, microcontrollers, digital signal processors (DSPs), an application specific integrated circuits (ASICs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 1204 may include specialized processors that perform specific functions, and that may be configured, augmented or controlled by one of the software modules 1216. The one or more processors 1204 may be configured through a combination of software modules 1216 loaded during initialization, and further configured by loading or unloading one or more software modules 1216 during operation.

In the illustrated example, the processing circuit 1202 may be implemented with a bus architecture, represented generally by the bus 1210. The bus 1210 may include any number of interconnecting buses and bridges depending on the specific application of the processing circuit 1202 and the overall design constraints. The bus 1210 links together various circuits including the one or more processors 1204, and storage 1206. Storage 1206 may include memory devices and mass storage devices, and may be referred to herein as computer-readable media and/or processor-readable media. The bus 1210 may also link various other circuits such as timing sources, timers, peripherals, voltage regulators, and power management circuits. A bus interface 1208 may provide an interface between the bus 1210 and one or more transceivers 1212. A transceiver 1212 may be provided for each networking technology supported by the processing circuit. In some instances, multiple networking technologies may share some or all of the circuitry or processing modules found in a transceiver 1212. Each transceiver 1212 provides a means for communicating with various other apparatus over a transmission medium. Depending upon the nature of the apparatus, a user interface 1218 (e.g., keypad, display, speaker, microphone, joystick) may also be provided, and may be communicatively coupled to the bus 1210 directly or through the bus interface 1208.

A processor 1204 may be responsible for managing the bus 1210 and for general processing that may include the execution of software stored in a computer-readable medium that may include the storage 1206. In this respect, the processing circuit 1202, including the processor 1204, may be used to implement any of the methods, functions and techniques disclosed herein. The storage 1206 may be used for storing data that is manipulated by the processor 1204 when executing software, and the software may be configured to implement any one of the methods disclosed herein.

One or more processors 1204 in the processing circuit 1202 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1206 or in an external computer readable medium. The external computer-readable medium and/or storage 1206 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1206 may also include, by way of example, a carrier wave, a transmission line, and any other suitable medium for transmitting software and/or instructions that may be accessed and read by a computer. Computer-readable medium and/or the storage 1206 may reside in the processing circuit 1202, in the processor 1204, external to the processing circuit 1202, or be distributed across multiple entities including the processing circuit 1202. The computer-readable medium and/or storage 1206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1206 may maintain software maintained and/or organized in loadable code segments, modules, applications, programs, etc., which may be referred to herein as software modules 1216. Each of the software modules 1216 may include instructions and data that, when installed or loaded on the processing circuit 1202 and executed by the one or more processors 1204, contribute to a run-time image 1214 that controls the operation of the one or more processors 1204. When executed, certain instructions may cause the processing circuit 1202 to perform functions in accordance with certain methods, algorithms and processes described herein.

Some of the software modules 1216 may be loaded during initialization of the processing circuit 1202, and these software modules 1216 may configure the processing circuit 1202 to enable performance of the various functions disclosed herein. For example, some software modules 1216 may configure internal devices and/or logic circuits 1222 of the processor 1204, and may manage access to external devices such as the transceiver 1212, the bus interface 1208, the user interface 1218, timers, mathematical coprocessors, and so on. The software modules 1216 may include a control program and/or an operating system that interacts with interrupt handlers and device drivers, and that controls access to various resources provided by the processing circuit 1202. The resources may include memory, processing time, access to the transceiver 1212, the user interface 1218, and so on.

One or more processors 1204 of the processing circuit 1202 may be multifunctional, whereby some of the software modules 1216 are loaded and configured to perform different functions or different instances of the same function. The one or more processors 1204 may additionally be adapted to manage background tasks initiated in response to inputs from the user interface 1218, the transceiver 1212, and device drivers, for example. To support the performance of multiple functions, the one or more processors 1204 may be configured to provide a multitasking environment, whereby each of a plurality of functions is implemented as a set of tasks serviced by the one or more processors 1204 as needed or desired. In one example, the multitasking environment may be implemented using a timesharing program 1220 that passes control of a processor 1204 between different tasks, whereby each task returns control of the one or more processors 1204 to the timesharing program 1220 upon completion of any outstanding operations and/or in response to an input such as an interrupt. When a task has control of the one or more processors 1204, the processing circuit is effectively specialized for the purposes addressed by the function associated with the controlling task. The timesharing program 1220 may include an operating system, a main loop that transfers control on a round-robin basis, a function that allocates control of the one or more processors 1204 in accordance with a prioritization of the functions, and/or an interrupt driven main loop that responds to external events by providing control of the one or more processors 1204 to a handling function.

The following flowcharts illustrate methods and processes performed or operative on network elements adapted or configured in accordance with certain aspects disclosed herein. The methods and processes may be implemented in any suitable network technology, including 3G, 4G, and 5G technologies, to name but a few. Accordingly, the claims are not restricted to a single network technology. In this regard, a reference to a “UE” may be understood to refer also to a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A reference to an “eNodeB” or “eNB” may be understood to refer to a base station, a base transceiver station, a radio base station, a radio transceiver, a transceiver function, a basic service set, an extended service set, or some other suitable terminology. A reference to an MME may refer also to an entity that serves as an authenticator in the serving network and/or a primary service delivery node such as a Mobile Switching Center, for example. A reference to the HSS may refer also to a database that contains user-related and subscriber-related information, provides support functions in mobility management, call and session setup, and/or user authentication and access authorization, including, for example, a Home Location Register (HLR), Authentication Centre (AuC) and/or an authentication, authorization, and accounting (AAA) server.

According to certain aspects disclosed herein, a UE may be configured or adapted to control anchor migration when connected through a mesh network. The UE may have a connection to a node that is part of a wireless mesh network that includes a routing plane. The routing plane may be maintained using a distributed routing protocol. The UE may maintain an association with a first local anchor that is reachable within the wireless mesh network using the routing plane. The UE may exchange packets with a corresponding node outside of the wireless mesh network. The packets may be directed via the first local anchor. Packets may be directed using encapsulation and/or tunneling. The UE may receive a signal from a node of the wireless mesh network, where the signal includes information corresponding to at least one local anchor that is reachable within the wireless mesh network. The information may include information pertaining to a path cost to and/or from the local anchor, loading of the local anchor, etc. The path cost may be related to SNR, SINR, hop-count, capacity, latency, etc. The UE may make a determination based at least in part on the information that a second local anchor that is reachable within the wireless network is preferred over the first local anchor. The UE may send a signal to migrate the association from the first local anchor to the second local anchor. The UE may exchange packets with the corresponding node. The packets may be directed via the second local anchor. Packets exchanged with the correspondent node may be further directed via a global anchor between the local anchor and the corresponding node.

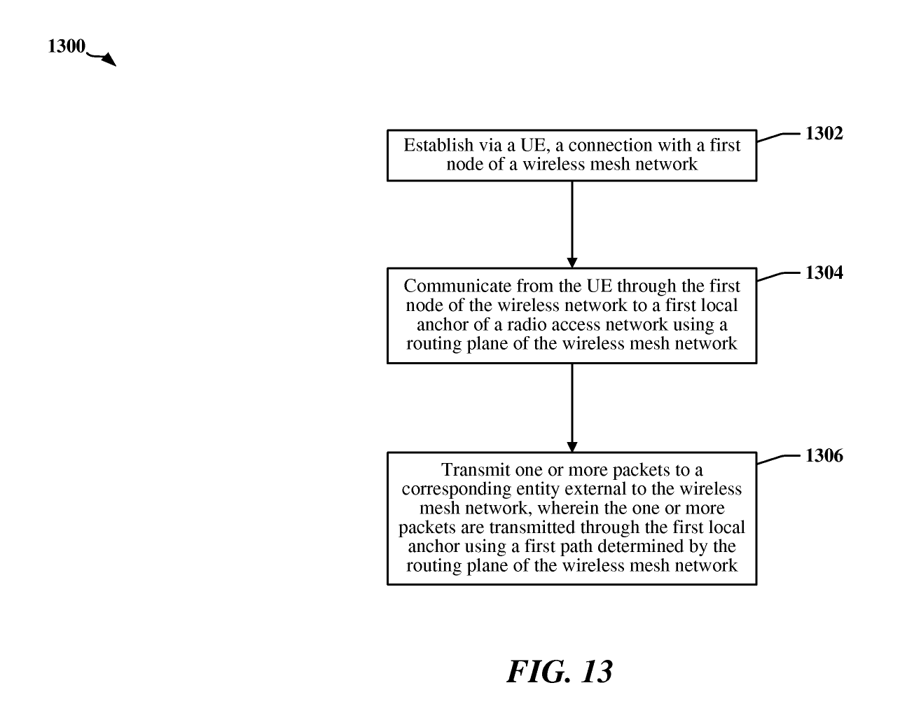

FIG. 13 is a flow chart 1300 of a method of wireless communication performed at a UE. At block 1302, the UE may establish a connection with a first node of a wireless mesh network.

At block 1304, the UE may establish from the UE through the first node of the wireless network to a first local anchor of a radio access network using a routing plane of the wireless mesh network.

At block 1304, the UE may transmit one or more packets to a corresponding entity external to the wireless mesh network. The one or more packets may be transmitted through the first local anchor using a first path determined by the routing plane of the wireless mesh network. In some instances, the UE may maintain an association with the first local anchor when the one or more packets are carried through the wireless mesh network on a second path determined by the routing plane of the wireless mesh network. The UE may maintain the routing plane via a distributed routing protocol. In one example, the UE and the nodes of the wireless mesh network may maintain corresponding routing tables that may be used to manage handling of packets at the nodes and/or UE.

In some examples, the UE may determine a first path metric through the wireless mesh network to the first local anchor, where the first path metric may include a first hop count, a first aggregated path cost or a first path weight derived from a routing protocol used in the wireless mesh network. The UE may determine determining a second path metric through the wireless mesh network to a second local anchor, where the second path metric includes a second hop count, a second aggregated path cost or a second path weight derived from the routing protocol used in the wireless mesh network. The UE may move, or cause to be moved, a bearer established between the UE and a global anchor of the radio access network to the second local anchor when it is determined that the second hop count is lower than the first hop count, the second aggregated path cost is lower than the first aggregated path cost or the second path weight is lower than the first path weight. In a first example, the bearer may be moved by transmitting a message through the wireless mesh network to a managing entity of the radio access network. The message may effect a change in current serving local anchor from the first local anchor to the second local anchor. In a second example, the bearer may be moved by receiving, from a managing entity of the radio access network, a configuration that controls determination and transmission of path metrics.

In some examples, the UE may determine a first path metric through the wireless mesh network to the first local anchor, where the first path metric includes a first signal strength, a first SNR, a first SINR, a first throughput, a first capacity latency or a first loading. The UE may determine a second path metric through the wireless mesh network to a second local anchor. The second path metric may include a second signal strength, a second SNR, a second SINR, a second capacity latency or a second loading. The UE may move, or cause to be moved, a bearer established between the UE and a global anchor of the radio access network to the second local anchor when it is determined that the second signal strength is greater than the first signal strength, the second SNR is greater than the first SNR, the second SINR is greater than the first SINR, the second capacity latency is less than the first capacity latency, or the second loading is greater than the first loading. In one example, the bearer may be moved by transmitting the first path metric and the second path metric to a managing entity of a radio access network, where the managing entity is configured to selectively initiate reestablishment of the bearer established between the UE and the global anchor of the radio access network based on a comparison of the first path metric and the second path metric. In another example, the bearer may be moved by receiving from a managing entity of the radio access network a configuration that controls determination and transmission of path metrics.

In some instances, the UE may receive, from a managing entity of the radio access network a configuration that identifies a list of target local anchors, determine a path metric for each local anchor in the list of target local anchors, and transmit the path metric for each local anchor to the managing entity of the radio access network.

In some instances, the UE may receive a request identifying one or more other local anchors, determine, in response to the request, a path metric for each of the one or more other local anchors, and transmit the path metric for each one or more other local anchors to the managing entity of the radio access network.

According to certain aspects, the UE may establish a bearer between the UE and a global anchor of the radio access network through the first local anchor of the radio access network. Bearer traffic may be carried through the wireless mesh network using one or more routes determined by the routing plane of the wireless mesh network.

According to certain aspects, the UE may receive a local anchor migration message from a network entity, and move a bearer established between the UE and a global anchor of the radio access network from the first local anchor to a second local anchor in response to the anchor migration message. Bearer traffic may be relayed through the second local anchor after the bearer is moved.

According to certain aspects, the UE establish a tunnel between the UE and the global anchor using a tunneling protocol.

According to certain aspects, the UE may transmit one or more packets to the corresponding entity of the radio access network by encapsulating data to be transmitted to a core network in encapsulated packets using a tunneling protocol, and transmitting the encapsulated packets to the core network.

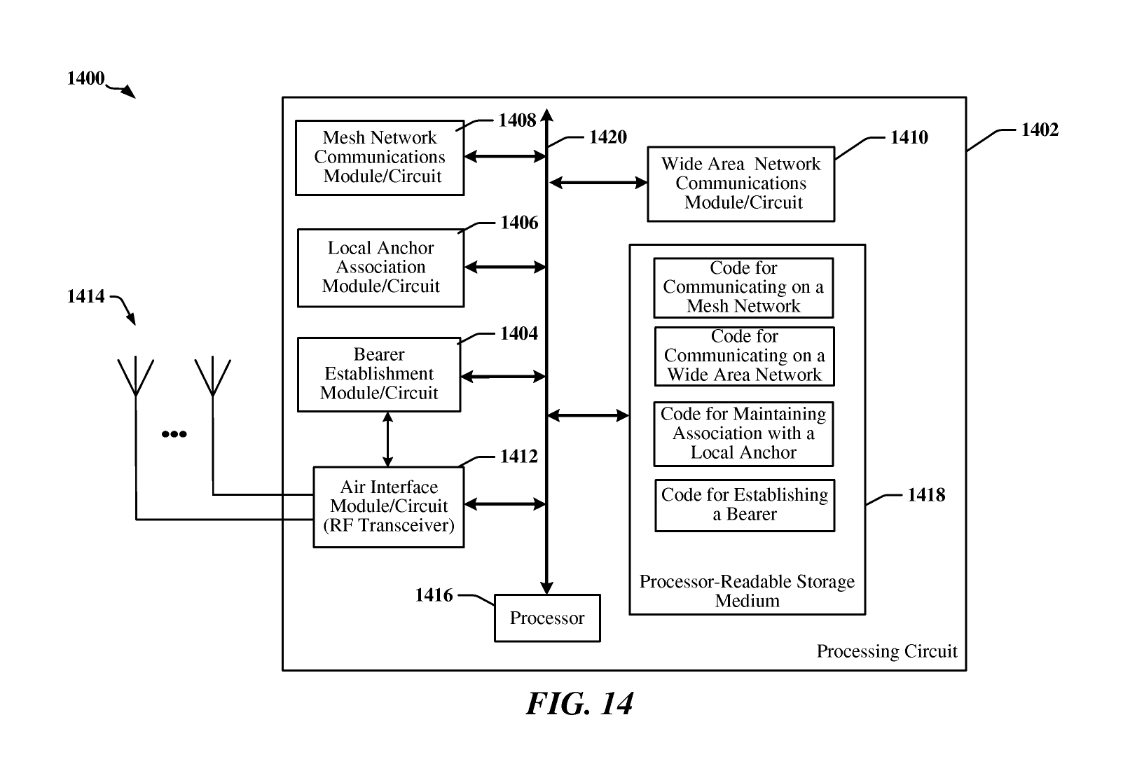

FIG. 14 is a diagram illustrating a simplified example of a hardware implementation for an apparatus 1400 employing a processing circuit 1402. The processing circuit typically has a processor 1416 that may include one or more of a microprocessor, microcontroller, digital signal processor, a sequencer and a state machine. The processing circuit 1402 may be implemented with a bus architecture, represented generally by the bus 1420. The bus 1420 may include any number of interconnecting buses and bridges depending on the specific application of the processing circuit 1402 and the overall design constraints. The bus 1420 links together various circuits including one or more processors and/or hardware modules, represented by the processor 1416, the modules or circuits 1404, 1406, 1408 and 1410, air interface circuits 1412 configurable to communicate using one or more antennas 1414 and the computer-readable storage medium 1418. The bus 1420 may also link various other circuits such as timing sources, peripherals, voltage regulators, and power management circuits, which are well known in the art, and therefore, will not be described any further.

The processor 1416 is responsible for general processing, including the execution of software stored on the computer-readable storage medium 1418. The software, when executed by the processor 1416, causes the processing circuit 1402 to perform the various functions described supra for any particular apparatus. The computer-readable storage medium 1418 may also be used for storing data that is manipulated by the processor 1416 when executing software, including data to be encoded in wireless signals transmitted over the antennas 1414 and/or data decoded from wireless signals received using the antennas 1414. The air interface circuits 1412 may be include certain of the processors and circuits illustrated in FIG. 5, and may include air interface circuits that may be used separately or commonly in wide area networks and in wireless mesh networks. The processing circuit 1402 further includes at least one of the modules 1404, 1406, 1408 and 1410. The modules 1404, 1406 and 1408 may be software modules running in the processor 1416, resident/stored in the computer-readable storage medium 1418, one or more hardware modules coupled to the processor 1416, or some combination thereof. The modules 1404, 1406, 1408 and/or 1410 may include microcontroller instructions, state machine configuration parameters, or some combination thereof.

In one configuration, the apparatus 1400 for wireless communication includes modules and/or circuits 1408, 1412, and antennas 1414 configured to establish a connection with a first node of a wireless mesh network and communicate with a second node of the wireless mesh network using a routing plane of the wireless mesh network, modules and/or circuits 1406, 1408, 1412, and antennas 1414 configured to establish and maintain an association with a first local anchor of a radio access network, and modules and/or circuits 1406, 1408, 1410, 1412, and antennas 1414 configured to exchange packets with a corresponding entity of the radio access network external to the wireless mesh network, where the packets are communicated through the first local anchor.

In one example, the apparatus 1400 may include a processing circuit configured or programmed to determine whether a second local anchor accessible through the wireless mesh network provides better connectivity to the corresponding entity of the radio access network than the first local anchor based on information received from one or more nodes of the wireless mesh network. The apparatus 1400 may include modules and/or circuits 1404 configured to establish a hearer between the apparatus 1400 and a global anchor of the radio access network, and to move the bearer to the second local anchor when it is determined that the second local anchor provides improved connectivity to the corresponding entity of the radio access network. Determining whether the second local anchor provides better connectivity includes evaluating a path metric derived from metrics related to at least one path through the wireless mesh network, where, the path metric is derived from a routing protocol used in the wireless mesh network and includes a hop count, an aggregated path cost or a path weight. The path metric may include a component related to a path through the wide area radio access network. For example, the apparatus 1400 may be provided in the communication device 550 illustrated in FIG. 5, and the path metrics may be obtained or analyzed using one or more processors 556, 558, 559, and/or 568. Determining whether the second local anchor provides better connectivity may include evaluating a path metric derived from link metrics of one or more wireless links in the wireless mesh network, where the link metrics include signal strength, SNR, SINR, interference, throughput, capacity latency or load. Moving the bearer may include transmitting a message through the wireless mesh network to a managing entity of the radio access network, where the message effects a change in current serving local anchor from the first local anchor to the second local anchor.

In some instances, the apparatus 1400 may be configured to determine path metrics for a plurality of paths through the wireless mesh network, each path providing connectivity to one of a plurality of local anchors connected to the wireless mesh network. The apparatus 1400 may be configured to transmit the path metrics to a managing entity of a core network. The managing entity may be configured to initiate reestablishment of the bearer through a second local anchor when the path metrics indicate that a path from the apparatus 1400 to the second local anchor provides better performance that a current path to the first local anchor.

In some examples, the apparatus 1400 may be configured to evaluate path metrics for a plurality of paths through the wireless mesh network to obtain evaluation information, each path providing connectivity to one of a plurality of local anchors connected to the wireless mesh network. The apparatus 1400 may be configured to transmit the evaluation information to the core network, which may be configured to initiate reestablishment of the bearer through a second local anchor when the evaluation information determines that a path from the apparatus 1400 to the second local anchor provides better performance that a current path to the first local anchor.

In some examples, the apparatus 1400 may receive a local anchor migration message from a network entity and responsive to the message, the apparatus 1400 may be configured to move a bearer established between the apparatus 1400 and a global anchor of the radio access network from the first local anchor to a second local anchor. Bearer traffic may be relayed through the second local anchor after the bearer is moved. The apparatus 1400 may establish a tunnel between the apparatus 1400 and the global anchor using a tunneling protocol.

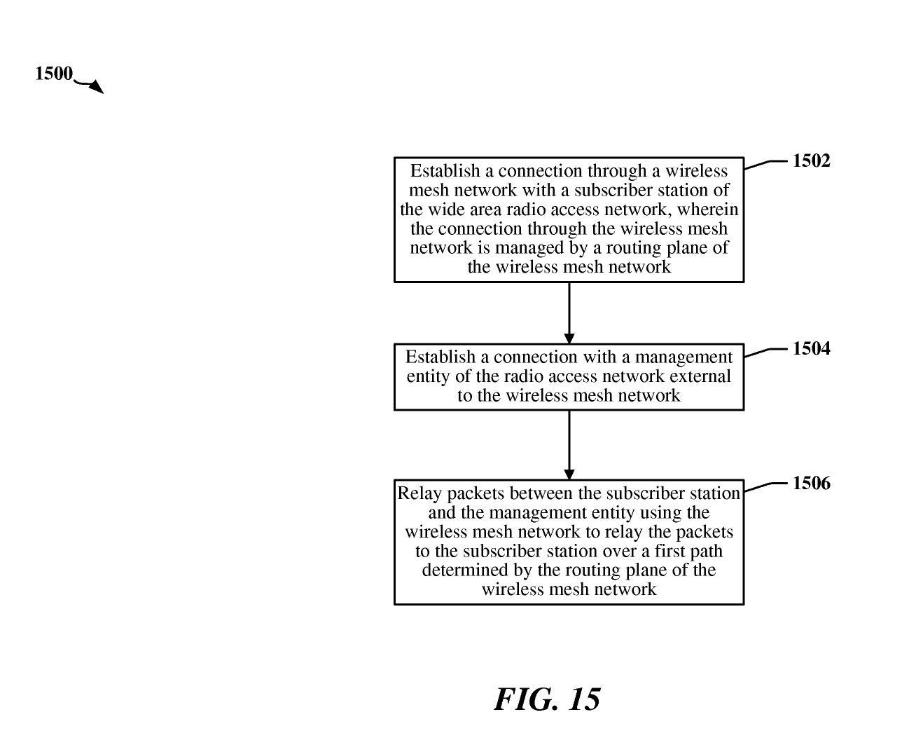

FIG. 15 is a flow chart 1500 of a method of wireless communication, which may be performed by a device that serves as a local anchor of a wide area radio access network.

At block 1502, the device may establish a connection through a wireless mesh network with a subscriber station of the wide area radio access network. The connection through the wireless mesh network may be managed by a routing plane of the wireless mesh network.

At block 1504, the device may establish a connection with a management entity of the radio access network external to the wireless mesh network.

At block 1506, the device may relay packets between the subscriber station and the management entity using the wireless mesh network to relay the packets to the subscriber station over a first path determined by the routing plane of the wireless mesh network.

According to certain aspects, the device may maintain an association with the subscriber station when one or more packets are carried through the wireless mesh network on a second path determined by the routing plane of the wireless mesh network. The device may establish a bearer coupling the subscriber station and a global anchor of the radio access network. Bearer traffic may be transmitted through the wireless mesh network using one or more routes determined by the routing plane of the wireless mesh network. Packets may be relayed between the subscriber station and the management entity through a tunnel established between the subscriber station and a global anchor using a tunneling protocol.

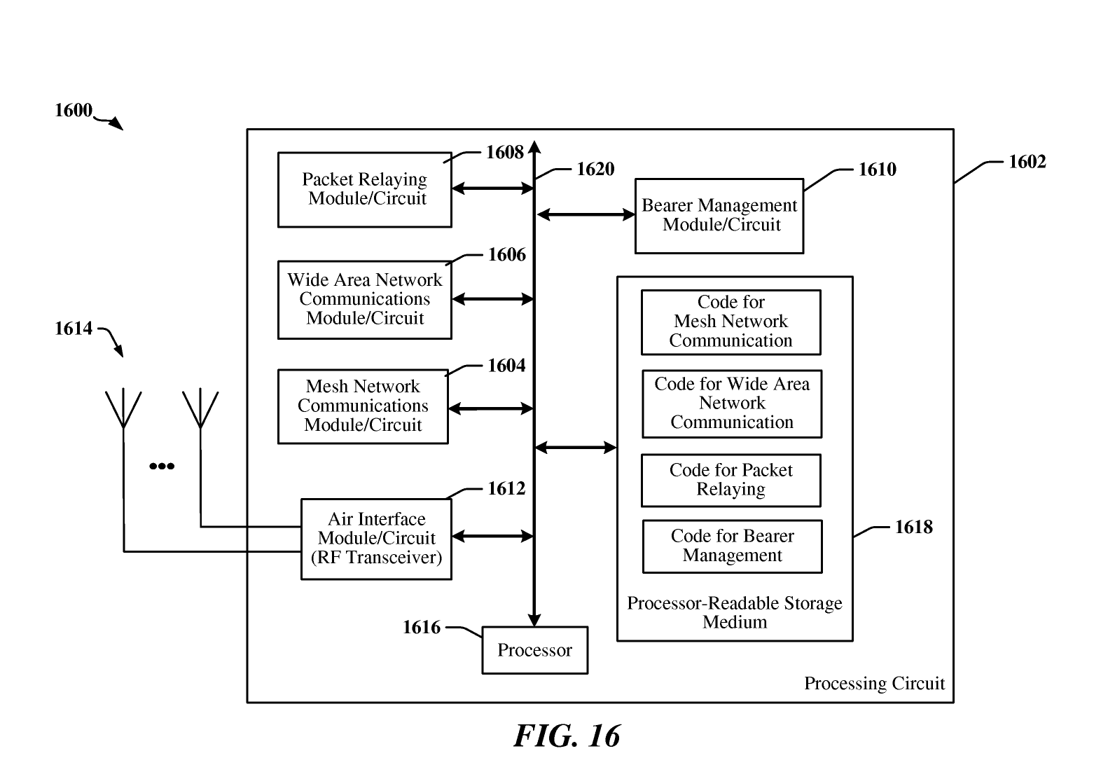

FIG. 16 is a diagram illustrating a simplified example of a hardware implementation for an apparatus 1600 employing a processing circuit 1602. The processing circuit typically has a processor 1616 that may include one or more of a microprocessor, microcontroller, digital signal processor, a sequencer and a state machine. The processing circuit 1602 may be implemented with a bus architecture, represented generally by the bus 1620. The bus 1620 may include any number of interconnecting buses and bridges depending on the specific application of the processing circuit 1602 and the overall design constraints. The bus 1620 links together various circuits including one or more processors and/or hardware modules, represented by the processor 1616, the modules or circuits 1604, 1606, 1608 and 1610, air interface circuits 1612 configurable to communicate using one or more antennas 1614 and the computer-readable storage medium 1618. The bus 1620 may also link various other circuits such as timing sources, peripherals, voltage regulators, and power management circuits, which are well known in the art, and therefore, will not be described any further.

The processor 1616 is responsible for general processing, including the execution of software stored on the computer-readable storage medium 1618. The software, when executed by the processor 1616, causes the processing circuit 1602 to perform the various functions described supra for any particular apparatus. The computer-readable storage medium 1618 may also be used for storing data that is manipulated by the processor 1616 when executing software, including data to be encoded in wireless signals transmitted over the antennas 1614 and/or data decoded from wireless signals received using the antennas 1614. The air interface circuits 1612 may be include certain of the processors and circuits illustrated in FIG. 5, and may include air interface circuits that may be used separately or commonly in wide area networks and in wireless mesh networks. The processing circuit 1602 further includes at least one of the modules 1604, 1606, 1608 and 1610. The modules 1604, 1606, 1608 and 1610 may be software modules running in the processor 1616, resident/stored in the computer-readable storage medium 1618, one or more hardware modules coupled to the processor 1616, or some combination thereof. The modules 1604, 1606, 1608 and 1610 may include microcontroller instructions, state machine configuration parameters, or some combination thereof.

In one configuration, the apparatus 1600 for wireless communication includes modules and/or circuits 1604, 1612, and antennas 1614 configured to establish a connection with a subscriber station of a wide area network, modules and/or circuits 1606, 1612, and antennas 1614 operable to establish a connection with a management entity of the radio access network external to the wireless mesh network, modules and/or circuits 1604, 1606, 1608, 1612, and antennas 1614 configured to relay packets between the subscriber station and the management entity including the modules and/or circuits 1604, 1612, and antennas 1614 which may be configured to relay the packets to the subscriber station over a first path through the wireless mesh network as determined by the routing plane of the wireless mesh network. The apparatus 1600 for wireless communication may include modules and/or circuits 1604, 1606, 1610, 1612, and antennas 1614 that are configurable in a manner that enables the apparatus 1600 to establish and maintain a bearer coupling the subscriber station and a global anchor of the radio access network.

The apparatus 1600 may be operated as a local anchor of the wide area radio access network. In one example, the apparatus 1600 may be provided in the scheduling entity 510 illustrated in FIG. 5, and the modules and/or circuits 1604, 1606, 1610, 1612 may be implemented using one or more of the processors 516, 570, 574, and/or 575 depicted in FIG. 5. In one example, the apparatus may be operated as a local anchor coupled to a wide area radio access network. The air interface circuits 1612 may include or be configured to provide a wireless transceiver that couples the apparatus 1600 to a wireless mesh network. The processing circuit 1602 may be configured to establish a connection through the wireless mesh network with a subscriber station of the wide area radio access network. The connection through the wireless mesh network may be managed by a routing plane of the wireless mesh network. The processing circuit 1602 may be configured to establish a connection with a management entity of the radio access network external to the wireless mesh network. The processing circuit 1602 may be configured to relay packets between the subscriber station and the management entity using the wireless mesh network to relay the packets to the subscriber station over a first path determined by the routing plane of the wireless mesh network.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communication performed at a user equipment (UE), comprising:
establishing, via the UE, a connection with a first node of a wireless mesh network;
communicating from the UE through the first node of the wireless network to a first local anchor of a radio access network using a routing plane of the wireless mesh network; and
transmitting one or more packets to a corresponding entity external to the wireless mesh network, wherein the one or more packets are transmitted through the first local anchor using a first path determined by the routing plane of the wireless mesh network.

2. The method of claim 1, further comprising:
maintaining an association with the first local anchor when the one or more packets are carried through the wireless mesh network on a second path determined by the routing plane of the wireless mesh network.

3. The method of claim 1, further comprising:
maintaining the routing plane via a distributed routing protocol.

4. The method of claim 1, further comprising:
determining a first path metric through the wireless mesh network to the first local anchor, wherein the first path metric includes a first hop count, a first aggregated path cost or a first path weight derived from a routing protocol used in the wireless mesh network;
determining a second path metric through the wireless mesh network to a second local anchor, wherein the second path metric includes a second hop count, a second aggregated path cost or a second path weight derived from the routing protocol used in the wireless mesh network; and
moving a bearer established between the UE and a global anchor of the radio access network to the second local anchor when it is determined that the second hop count is lower than the first hop count, the second aggregated path cost is lower than the first aggregated path cost or the second path weight is lower than the first path weight.

5. The method of claim 4, wherein moving the bearer comprises:
transmitting a message through the wireless mesh network to a managing entity of the radio access network, wherein the message effects a change in current serving local anchor from the first local anchor to the second local anchor.

6. The method of claim 4, wherein moving the bearer comprises:
receiving from a managing entity of the radio access network a configuration that controls determination and transmission of path metrics.

7. The method of claim 1, further comprising:
determining a first path metric through the wireless mesh network to the first local anchor, wherein the first path metric includes a first signal strength, a first signal-to-noise ratio (SNR), a first signal-to-interference ratio (SINR), a first throughput, a first capacity latency or a first loading;
determining a second path metric through the wireless mesh network to a second local anchor, wherein the second path metric includes a second signal strength, a second signal-to-noise ratio (SNR), a second signal-to-interference ratio (SINR), a second capacity latency or a second loading; and
moving a bearer established between the UE and a global anchor of the radio access network to the second local anchor when it is determined that the second signal strength is greater than the first signal strength, the second SNR is greater than the first SNR, the second SINR is greater than the first SINR, the second capacity latency is less than the first capacity latency, or the second loading is greater than the first loading.

8. The method of claim 7, wherein moving the bearer comprises:
transmitting the first path metric and the second path metric to a managing entity of a radio access network, wherein the managing entity is configured to selectively initiate reestablishment of the bearer established between the UE and the global anchor of the radio access network based on a comparison of the first path metric and the second path metric.

9. The method of claim 7, wherein moving the bearer comprises:
receiving from a managing entity of the radio access network a configuration that controls determination and transmission of path metrics.

10. The method of claim 7, further comprising:
receiving from a managing entity of the radio access network a configuration that identifies a list of target local anchors;
determining a path metric for each local anchor in the list of target local anchors; and
transmitting the path metric for each local anchor to the managing entity of the radio access network.

11. The method of claim 7, further comprising:
receiving a request identifying one or more other local anchors;
responsive to the request, determining a path metric for each of the one or more other local anchors; and
transmitting the path metric for each one or more other local anchors to a managing entity of the radio access network.

12. The method of claim 1, further comprising:
establishing a bearer between the UE and a global anchor of the radio access network through the first local anchor of the radio access network, wherein bearer traffic is carried through the wireless mesh network using one or more routes determined by the routing plane of the wireless mesh network.

13. The method of claim 1, further comprising:
receiving a local anchor migration message from a network entity; and
moving a bearer established between the UE and a global anchor of the radio access network from the first local anchor to a second local anchor in response to the anchor migration message,
wherein bearer traffic is relayed through the second local anchor after the bearer is moved.

14. The method of claim 1, further comprising:
establishing a tunnel between the UE and a global anchor using a tunneling protocol.

15. The method of claim 1, wherein transmitting the one or more packets to the corresponding entity of the radio access network comprises:
encapsulating data to be transmitted to a core network in encapsulated packets using a tunneling protocol; and
transmitting the encapsulated packets to the core network.

16. A method for wireless communication performed at a local anchor of a wide area radio access network, comprising:
establishing a connection through a wireless mesh network with a subscriber station of the wide area radio access network, wherein the connection through the wireless mesh network is managed by a routing plane of the wireless mesh network;
establishing a connection with a management entity of the radio access network external to the wireless mesh network; and
relaying packets between the subscriber station and the management entity using the wireless mesh network to relay the packets to the subscriber station over a first path determined by the routing plane of the wireless mesh network.

17. The method of claim 16, further comprising:
maintaining an association with the subscriber station when one or more packets are carried through the wireless mesh network on a second path determined by the routing plane of the wireless mesh network.

18. The method of claim 16, further comprising:
establishing a bearer coupling the subscriber station and a global anchor of the radio access network, wherein bearer traffic is carried through the wireless mesh network using one or more routes determined by the routing plane of the wireless mesh network.

19. The method of claim 16, wherein packets are relayed between the subscriber station and the management entity through a tunnel established between the subscriber station and a global anchor using a tunneling protocol.

20. A computer-readable storage medium comprising code for:
establishing, via a user equipment (UE), a connection with a first node of a wireless mesh network;
communicating from the UE through the first node of the wireless network to a first local anchor of a radio access network using a routing plane of the wireless mesh network; and
transmitting one or more packets to a corresponding entity external to the wireless mesh network, wherein the one or more packets are transmitted through the first local anchor using a first path determined by the routing plane of the wireless mesh network.

21. The storage medium of claim 20, further comprising code for:
maintaining an association with the first local anchor when the one or more packets are carried through the wireless mesh network on a second path determined by the routing plane of the wireless mesh network.

22. The storage medium of claim 20, further comprising code for:
determining a first path metric through the wireless mesh network to the first local anchor, wherein the first path metric includes a first hop count, a first aggregated path cost or a first path weight derived from a routing protocol used in the wireless mesh network;
determining a second path metric through the wireless mesh network to a second local anchor, wherein the second path metric includes a second hop count, a second aggregated path cost or a second path weight derived from the routing protocol used in the wireless mesh network;
transmitting a message through the wireless mesh network to a managing entity of the radio access network, wherein the message effects a change in current serving local anchor from the first local anchor to the second local anchor; and
moving a bearer established between the UE and a global anchor of the radio access network to the second local anchor when it is determined that the second hop count is lower than the first hop count, the second aggregated path cost is lower than the first aggregated path cost or the second path weight is lower than the first path weight.

23. The storage medium of claim 20, further comprising code for:
determining a first path metric through the wireless mesh network to the first local anchor, wherein the first path metric includes a first signal strength, a first signal-to-noise ratio (SNR), a first signal-to-interference ratio (SINR), a first throughput, a first capacity latency or a first loading;
determining a second path metric through the wireless mesh network to a second local anchor, wherein the second path metric includes a second signal strength, a second signal-to-noise ratio (SNR), a second signal-to-interference ratio (SINR), a second capacity latency or a second loading;
transmitting the first path metric and the second path metric to a managing entity of a radio access network, wherein the managing entity is configured to selectively initiate reestablishment of a bearer established between the UE and a global anchor of the radio access network based on a comparison of the first path metric and the second path metric; and
moving a bearer established between the and the global anchor of the radio access network to the second local anchor when it is determined that the second signal strength is greater than the first signal strength, the second SNR is greater than the first SNR, the second SINR is greater than the first SINR, the second capacity latency is less than the first capacity latency, or the second loading is greater than the first loading.

24. The storage medium of claim 20, further comprising code for:
receiving a message from a managing entity of the radio access network a configuration that controls determination and transmission of path metrics and a list of target local anchors;
responsive to the message, determining a path metric for each local anchor in the list of target local anchors; and
transmitting the path metric for each local anchor to the managing entity of the radio access network.

25. The storage medium of claim 20, further comprising code for:
establishing a bearer between the UE and a global anchor of the radio access network through the first local anchor of the radio access network, wherein bearer traffic is carried through the wireless mesh network using one or more routes determined by the routing plane of the wireless mesh network.

26. The storage medium of claim 20, further comprising code for:
receiving a local anchor migration message from a network entity;
moving a bearer established between the UE and a global anchor of the radio access network from the first local anchor to a second local anchor in response to the anchor migration message; and
establishing a tunnel between the UE and the global anchor using a tunneling protocol,
wherein bearer traffic is relayed through the second local anchor after the bearer is moved.

27. A local anchor coupled to a wide area radio access network, comprising:
a wireless transceiver configured to couple the local anchor to a wireless mesh network;
at least one processing circuit configured to:
establish a connection through the wireless mesh network with a subscriber station of the wide area radio access network, wherein the connection through the wireless mesh network is managed by a routing plane of the wireless mesh network;
establish a connection with a management entity of the radio access network external to the wireless mesh network; and
relay packets between the subscriber station and the management entity using the wireless mesh network to relay the packets to the subscriber station over a first path determined by the routing plane of the wireless mesh network.

28. The local anchor of claim 27, wherein the at least one processing circuit is configured to:
maintain an association with the subscriber station when one or more packets are carried through the wireless mesh network on a second path determined by the routing plane of the wireless mesh network.

29. The local anchor of claim 27, wherein the at least one processing circuit is configured to:
establish a bearer coupling the subscriber station and a global anchor of the radio access network;
transmit a first portion of the packets through the wireless mesh network to the subscriber station using one or more routes determined by the routing plane of the wireless mesh network; and
receive a second portion of the packets through the wireless mesh network from the subscriber station using the one or more routes determined by the routing plane of the wireless mesh network.

30. The local anchor of claim 27, wherein the packets are relayed between the subscriber station and the management entity through a tunnel established between the subscriber station and a global anchor using a tunneling protocol.
